(19) United States
(12) Patent Application Publication
(10) Pub. No.: US 2026/0295804 A1
(43) Pub. Date: Oct. 1, 2026

(54) POWER TOOL

(71) Applicant: MAKITA CORPORATION, Anjo-shi (JP)

(72) Inventor: Takumi HAYASHI, Anjo-shi (JP)

(73) Assignee: MAKITA CORPORATION, Anjo-shi (JP)

(21) Appl. No.: 19/633,021

(22) Filed: Mar. 30, 2026

(30) Foreign Application Priority Data
Mar. 31, 2025 (JP) 2025-057684
Dec. 11, 2025 (JP) 2025-245257

(51) Int. Cl. B25F 5/02; B24B 23/02; B24B 47/12; H02K 7/14; H02K 11/33

(52) U.S. Cl. CPC B25F 5/026; B24B 23/028; B24B 47/12; H02K 7/145; H02K 11/33

(57) ABSTRACT

A power tool includes a motor, a housing, a handle, and a controller. The handle is detachably attached to a plurality of handle attachment portions. The controller is configured to control driving of the motor. The handle includes a main body portion and a shaft portion. The main body portion includes a grip portion configured to be grippable by a user. The shaft portion is configured to be disposed at a protruding position of protruding from the main body portion toward the plurality of handle attachment portions. The housing includes a detection mechanism including a plurality of detection portions pressed by the shaft portion disposed at the protruding position when the handle is attached to the plurality of handle attachment portions. The detection mechanism outputs a signal, to the controller, in response to the plurality of detection portions being pressed by the shaft portion.

### CROSS-REFERENCE TO RELATED APPLICATION

The present application claims priority to Japanese Patent Application No. 2025-057684, filed on Mar. 31, 2025; and Japanese Patent Application No. 2025-245257, filed on Dec. 11, 2025. The contents of the foregoing applications are hereby fully incorporated herein by reference.

### TECHNICAL FIELD

The present disclosure relates to a power tool.

### BACKGROUND

A power tool is known to which a sub handle can be attached for improving operability of the power tool. For example, in United States Patent No. 7628219 (B2), a power tool is disclosed to which a sub handle including an electrostatic capacitance detection unit can be attached. In this power tool, the electrostatic capacitance detection unit detects changes in capacitance generated as a result of the sub handle being gripped by a user, and thus detects whether or not the sub handle is being gripped. A detection result of the electrostatic capacitance detection unit is output to a tool main body as an electric signal from the electrostatic capacitance detection unit of the sub handle.

### SUMMARY

In the known technology, in order to attach the sub handle to a main body of the power tool, connection terminals for electrically connecting the detection unit provided in the sub handle and the tool main body may be provided at coupling portions between the sub handle and the tool main body. Thus, in the known technology, there is a possibility that an appropriate detection result cannot be obtained if a connection failure occurs between the terminals when coupling the sub handle and the tool main body.

One non-limiting object of the present disclosure is to provide a power tool capable of appropriately detecting a detection result relating to a sub handle attachable to the power tool.

According to a non-limiting aspect of the present disclosure, a power tool is provided. The power tool includes a motor, a housing, a handle, and a controller. The motor includes an output shaft configured to rotate around a motor rotation axis. The housing houses the motor, and includes a plurality of handle attachment portions. The handle extends in one direction, and is detachably attached to any one of the plurality of handle attachment portions. The controller is configured to control driving of the motor. The handle includes a main body portion and a shaft portion. The main body portion includes a grip portion configured to be grippable by a user. The shaft portion is configured to be movable tot a protruding position in which the shaft portion protrudes from the main body portion toward the plurality of handle attachment portions. The housing includes a detection mechanism including a plurality of detection portions corresponding to the plurality of handle attachment portions, the plurality of detection portions being pressed by the shaft portion disposed at the protruding position when the handle is attached to the plurality of handle attachment portions. The detection mechanism outputs a signal to the controller, in response to the plurality of detection portions being pressed by the shaft portion.

According to the power tool according to the present aspect, an electrical connection terminal that couples the handle and the housing is not provided at the handle attachment portion. Thus, it is possible to suppress or prevent the occurrence of an electrical connection failure when coupling the handle and the housing, and information relating to the handle can be appropriately detected.

According to another non-limiting aspect of the present disclosure, a power tool is provided. The power tool includes a housing and a handle. The housing includes a plurality of handle attachment portions. The handle extends in one direction, and is detachably attached to any one of the plurality of handle attachment portions. The handle includes a main body portion and a fixing mechanism. The main body portion includes a grip portion configured to be grippable by a user. The fixing mechanism is configured to be switchable between a fixing state of fixing the handle attached to the plurality of handle attachment portions, and a non-fixing state in which the handle is removable from the plurality of handle attachment portions. The fixing mechanism includes (i) an operation portion configured to be switchable between a first position and a second position closer to the main body portion than the first position, and (ii) a fixing portion. The fixing portion is (i) configured to be disposed at an attaching position when the operation portion is disposed at the second position, the handle being attachable to the plurality of handle attachment portions at the attaching position, and (ii) configured to be disposed at a fixing position when the operation portion is disposed at the first position, the fixing position being a position of fixing the handle attached to the plurality of handle attachment portions.

According to the present aspect, the handle can be attached to and removed from the handle attachment portion by the simple method of operating the operation portion. Thus, the power tool can be provided in which the attachment and removal of the handle is easy.

### BRIEF DESCRIPTION OF THE DRAWINGS

FIG. 1 is a perspective view showing an external contour of a grinder according to a first embodiment.

FIG. 2 is a front view showing a configuration of a front end of the grinder.

FIG. 3 is a cross-sectional view showing a position III-III shown in FIG. 2.

FIG. 4 is a perspective view showing an external contour of a sub handle.

FIG. 5 is an explanatory view showing a fixing mechanism provided on the sub handle.

FIG. 6 is a cross-sectional view showing a position VI-VI shown in FIG. 5.

FIG. 7 is a perspective view showing a configuration of a handle attachment portion.

FIG. 8 is a cross-sectional view showing an internal configuration of the sub handle in a state of an operation portion being operated.

FIG. 9 is a cross-sectional view showing a position IX-IX shown in FIG. 2.

FIG. 10 is a cross-sectional view showing operation of a shaft portion when a grip lever is pressed.

FIG. 11 is a cross-sectional view showing a position XI-XI shown in FIG. 3.

FIG. 12 is a perspective view showing an external configuration of a detection unit.

FIG. 13 is an explanatory diagram showing an internal configuration of the detection unit.

FIG. 14 is an explanatory diagram showing a back surface configuration of the detection unit.

FIG. 15 is a cross-sectional view showing a position XV-XV shown in FIG. 2.

FIG. 16 is an explanatory diagram showing a configuration of an electrode unit.

FIG. 17 is an explanatory diagram showing a configuration of an outer electrode.

FIG. 18 is an explanatory diagram showing a configuration of an inner electrode.

FIG. 19 is an explanatory diagram showing a state in which the detection unit detects gripping of the sub handle.

FIG. 20 is a cross-sectional view showing a configuration of the detection unit included in a grinder according to another embodiment.

### DETAILED DESCRIPTION OF THE EMBODIMENTS

Hereinafter, representative and non-limiting specific examples of the present invention will be described in detail with reference to the drawings. This detailed description is simply intended to show, to a person skilled in the art, details for embodying a preferable example of the present invention, and is not intended to limit the scope of the present invention. Further, additional features and the invention disclosed below can be used separately or together with other features and inventions, in order to provide a further improved device, and a manufacturing method and a usage method thereof.

Further, combinations of features and processes disclosed in the following detailed description are not essential, in the broadest terms, when embodying the present invention, and, in particular, are given for describing representative specific examples of the present invention. Furthermore, when presenting additional and effective embodiments of the present invention, various features of representative specific examples described above and below, and various features described in independent and dependent claims need not necessarily be combined as in the specific examples given here, or in a given order.

All features listed in the present specification and/or in the scope of the claims are intended to be disclosed separately, and independently of each other, as limitations to the disclosure at the time of filing and to the claimed specific items, separately to the configuration of features listed in the embodiments and/or in the scope of the claims. Furthermore, description relating to all numerical ranges and groups or collections are treated as intending to disclose intermediate configurations related thereto, as limitations to the disclosure at the time of filing and to the claimed specific items.

In a non-limiting embodiment of the present disclosure, the handle may further include (i) a pressing detection portion provided on the grip portion and pressed as a result of the user gripping the grip portion, and (ii) a conversion mechanism configured to convert an operation of the pressed pressing detection portion into a linear movement of the shaft portion. The shaft portion may be configured to (i) be disposed at a housed position at which the shaft portion housed in the main body portion when the user is not gripping the grip portion, and (ii) be disposed at the protruding position by the pressing detection portion and the conversion mechanism when the user grips the grip portion.

According to this embodiment, the gripping of the handle can be detected without electrically connecting the handle and the housing. Thus, it is possible to prevent the occurrence of an electrical connection failure when coupling the handle and the housing, and the gripping of the handle can be appropriately detected.

In addition to the above-described embodiment, or in place of the above-described embodiment, the detection mechanism may further include (i) an inner electrode disposed surrounding the motor rotation axis, and (ii) an outer electrode disposed further to an outer side in a radial direction than the inner electrode, and disposed surrounding the inner electrode. The detection mechanism may output the signal to the controller in response to at least a part of the outer electrode pressed by the shaft portion being electrically connected to the inner electrode.

According to this embodiment, the detection mechanism can be realized using a simple configuration, using the inner electrode and the outer electrode.

In addition to the above-described embodiment, or in place of the above-described embodiment, the outer electrode may include (i) a conductive outer main body portion extending in a circumferential direction centering on the motor rotation axis, and (ii) an outer first elastic portion and an outer second elastic portion connected to the outer main body portion and having conductive properties and elasticity. The outer first elastic portion and the outer second elastic portion may function as the plurality of detection portions, and may be electrically connected to the inner electrode as a result of being pressed by the shaft portion.

According to this embodiment, by using elastic members having electrical conductivity as the detection portions of the detection mechanism, the outer electrode and the inner electrode are favorably switched between an electrically connected and non-connected state, and detection accuracy by the detection mechanism can be improved.

In addition to the above-described embodiment, or in place of the above-described embodiment, the outer first elastic portion may be a long plate including (i) a one end portion connected to the outer main body portion, and (ii) another end portion configured as a free end, and being pressed by the shaft portion. A width of the other end portion may be configured to be narrower than a width of the one end portion. The other end portion may be electrically connected to the inner electrode as a result of being pressed by the shaft portion.

According to this embodiment, compared to a case in which the width of the outer first elastic portion is configured to be uniform from the one end portion to the other end portion, it is possible to significantly displace the outer first elastic portion while suppressing or preventing damage of the one end portion of the outer first elastic portion.

In addition to the above-described embodiment, or in place of the above-described embodiment, the inner electrode may include (i) a conductive inner main body portion extending in the circumferential direction centering on the motor rotation axis, and (ii) an inner first elastic portion and an inner second elastic portion connected to the inner main body portion and having conductive properties and elasticity. The inner first elastic portion and the inner second elastic portion may be disposed at positions corresponding to the outer first elastic portion and the outer second elastic portion, and may be electrically connected to the outer first elastic portion and the outer second elastic portion pressed by the shaft portion.

According to this embodiment, by using elastic members as the sections coming into contact with the outer first elastic portion and the outer second elastic portion, when the outer first elastic portion and the outer second elastic portion are pressed and come into contact with the inner first elastic portion and the inner second elastic portion, it is difficult for the outer first elastic portion and the outer second elastic portion to be separated from and the inner first elastic portion and the inner second elastic portion. Thus, it is possible to suppress or prevent the occurrence of chattering at contact points between the outer first elastic portion and the outer second elastic portion, and the inner first elastic portion and the inner second elastic portion.

In addition to the above-described embodiment, or in place of the above-described embodiment, the inner first elastic portion may be a long plate including (i) a one end portion connected to the inner main body portion, and (ii) another end portion configured as a free end, and being electrically connected to the outer first elastic portion pressed by the shaft portion. A width of the other end portion may be configured to be narrower than a width of the one end portion. The other end portion may be electrically connected to the outer electrode pressed by the shaft portion.

According to this embodiment, compared to a case in which the width of the inner first elastic portion is configured to be uniform from the one end portion to the other end portion, it is possible to significantly displace the inner first elastic portion while suppressing or preventing damage of the one end portion of the inner first elastic portion. Further, by causing a modulus of elasticity of the other end of the inner first elastic portion to be lower than the modulus of elasticity of the one end, the inner first elastic portion can be bent using a comparatively small pressing force. Thus, the inner first elastic portion in the state of being pressed by the outer first elastic portion does not easily become separated from the outer first elastic portion, and it is possible to suppress or prevent the occurrence of chattering at the contact point between the outer first elastic portion and the inner first elastic portion.

In addition to the above-described embodiment, or in place of the above-described embodiment, the power tool may further include a restricting portion provided between the outer electrode and the inner electrode, and configured to restrict contact between the outer electrode and the inner electrode.

According to this embodiment, it is possible to suppress or prevent a failure due to an electrical short-circuit between the outer electrode and the inner electrode.

In addition to the above-described embodiment, or in place of the above-described embodiment, the handle may further include a fixing mechanism configured to be switchable between a fixing state of fixing the handle attached to the plurality of handle attachment portions, and a non-fixing state in which the handle is removable from the plurality of handle attachment portions. The fixing mechanism may include (i) an operation portion configured to be switchable between a first position and a second position closer to the main body portion than the first position, and (ii) a fixing portion. The fixing portion may be (i) configured to be disposed at an attaching position when the operation portion is disposed at the second position, the handle being attachable to the plurality of handle attachment portions at the attaching position, and (ii) configured to be disposed at a fixing position when the operation portion is disposed at the first position, the fixing position being a position of fixing the handle attached to the plurality of handle attachment portions.

According to this embodiment, the handle can be attached to and removed from the handle attachment portion by the simple method of operating the operation portion. Thus, the power tool can be provided in which the attachment and removal of the handle is easy.

In addition to the above-described embodiment, or in place of the above-described embodiment, the fixing mechanism may further include an urging member configured to urge the operation portion from the second position toward the first position.

According to this embodiment, by utilizing the urging force of the urging member, the operation portion can be easily switched between the first position and the second position. Thus, the power tool can be provided in which the attachment and removal of the handle is easy.

In addition to the above-described embodiment, or in place of the above-described embodiment, the fixing mechanism may further include (i) an outer cylinder connected to the operation portion, and configured to move in parallel to an extending direction of the shaft portion, and (ii) an inner cylinder including a holding portion configured to movably hold the fixing portion, the inner cylinder being movably housed in the outer cylinder. The inner cylinder may be configured to receive the plurality of handle attachment portions in the interior of the inner cylinder. With respect to the fixing portion, (i) at the fixing position, movement of the fixing portion to the outer side in the radial direction may be restricted by the outer cylinder, and the fixing portion may be configured to protrude to the interior of the inner cylinder and engage with the plurality of handle attachment portions received in the interior of the inner cylinder, and (ii) at the attaching position, the fixing portion may be configured to retract further to the outer side in the radial direction than an inner surface of the inner cylinder, and not engage with the plurality of handle attachment portions received in the interior of the inner cylinder.

According to this embodiment, the arrangement of the fixing portion can be switched by the simple configuration using the inner cylinder and the outer cylinder.

In addition to the above-described embodiment, or in place of the above-described embodiment, the shaft portion may be disposed further to an inner side in the radial direction than the outer cylinder and the inner cylinder, and may be configured to be movable with respect to the outer cylinder and the inner cylinder.

According to this embodiment, the power tool having a rational structure can be provided in which the attachment and removal of the handle is easy, and in which the shaft portion is efficiently arranged.

### First embodiment

### Configuration of power tool

A representative and non-limiting embodiment of the present disclosure will be described in detail with reference to the drawings. In the following embodiment, a hand-held electric disc grinder 100 (hereinafter also simply referred to as the “grinder 100”) is described as an example of a “power tool” according to the present disclosure. The grinder 100 is an example of a rotating tool configured to perform a machining operation, such as grinding or polishing, and cutting, on a workpiece, by rotationally driving a tip tool attached to a spindle. Note, however, that the power tool is not limited to only the grinder 100, and may be various types of power tool including a sub handle 60, such as a hammer drill, a driver drill, a belt sander, a chainsaw, or the like.

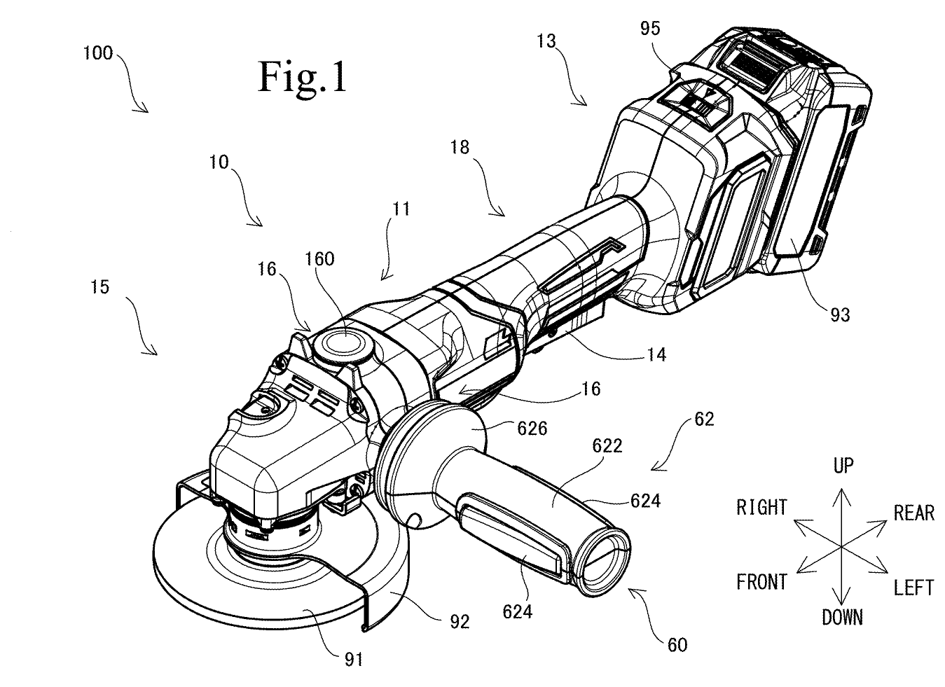

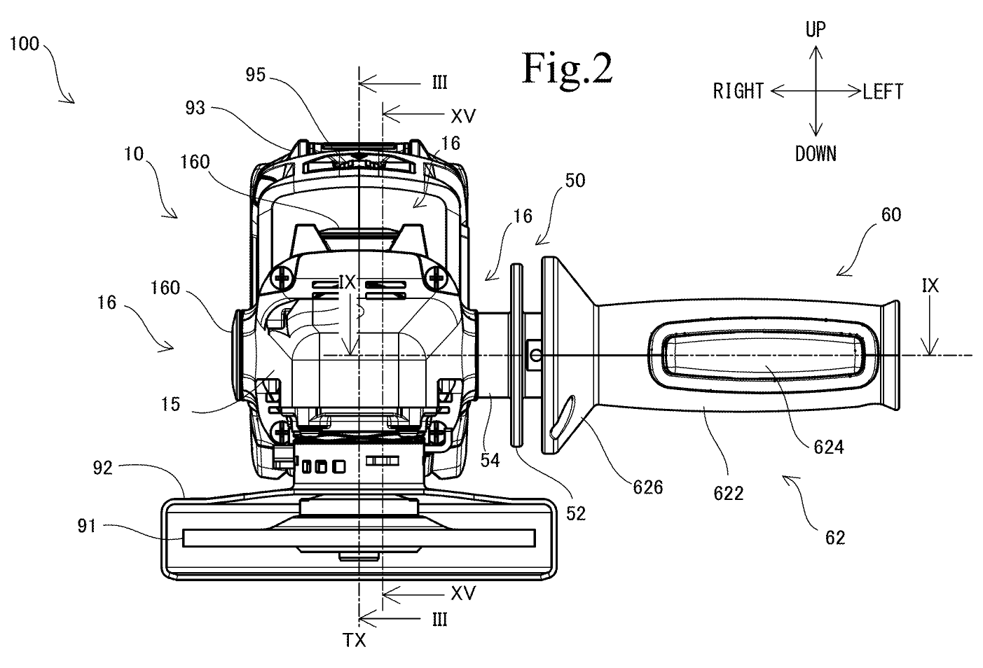

As shown in FIGS. 1 and 2, the grinder 100 includes a housing 10 that includes a grip portion 18, and the sub handle 60 that is configured to be grippable by a user. The sub handle 60 is detachably coupled to a plurality of handle attachment portions 16 formed at the outer surface of the housing 10.

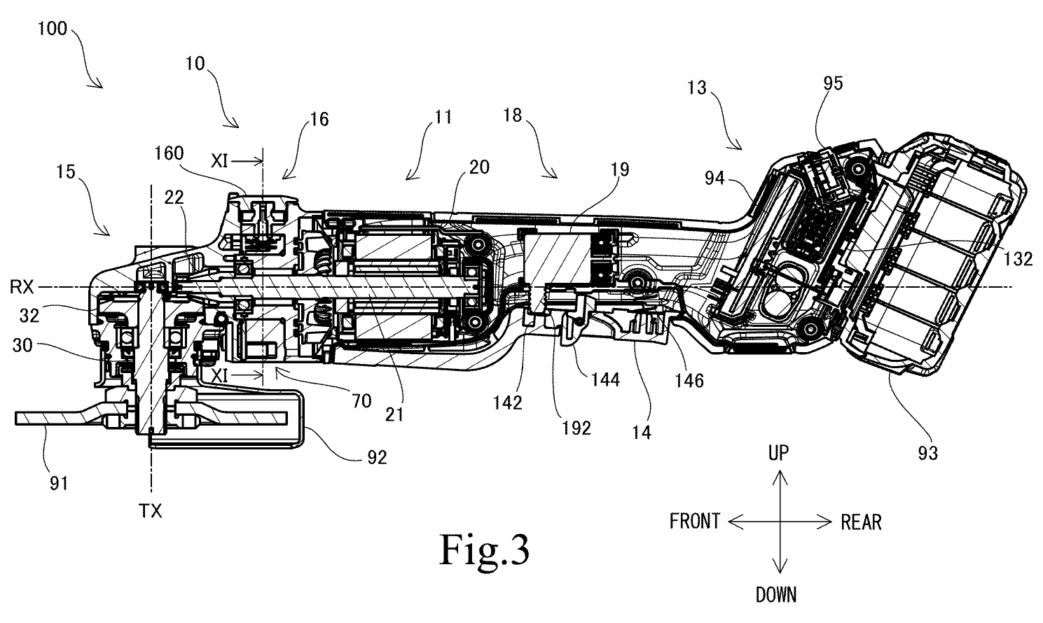

The housing 10 is a long-shaped hollow body, and forms an outer contour of the grinder 100. As shown in FIG. 3, a motor 20, and a spindle 30, and a detection unit 70 are housed in the housing 10, the spindle 30 being operably coupled to an output shaft 21 of the motor 20.

As shown in FIG. 3, the motor 20 is disposed such that a rotation axis RX of the output shaft 21 extends substantially in parallel to a long axis of the housing 10 and the grip portion 18. In the present embodiment, the motor 20 is configured to operate as a result of power being delivered from a rechargeable battery 93 detachably attached to the housing 10. Note, however, that the motor 20 may be configured to operate as a result of power being delivered from an external AC power source, via a power cord that extends from one end portion in the long axis direction of the housing 10.

The spindle 30 is disposed inside the other end portion in the long axis direction of the housing 10. The spindle 30 is supported inside the housing 10 so as to be able to rotate around a drive axis TX. The drive axis TX intersects the rotation axis RX of the output shaft 21. Note that, in the present embodiment, the drive axis TX is orthogonal to the rotation axis RX. From this, the grinder is also sometimes referred to as an angle grinder.

One end portion in an axial direction of the spindle 30 is exposed to the outside from the housing 10. A tip tool 91 is detachably attached to the one end portion of the spindle 30. As the tip tool 91 that can be mounted to the grinder 100, a grindstone, a cutting whetstone, a blade, a brush, or the like can be used, for example. The user selects the appropriate tip tool 91 in accordance with the content of a desired operation, and attaches the selected tip tool 91 to the grinder 100. The spindle 30 is driven to rotate around the drive axis TX by receiving power from the motor 20. As a result of the tip tool 91 being rotated in accordance with the rotation of the spindle 30, the grinder 100 can perform the machining operation on the workpiece. The grinder 100 can perform the machining operation of grinding, polishing, cutting, and the like on the workpiece, depending on the type of the tip tool 91. Note that the tip tool 91 is partially covered by a wheel cover 92 attached to the housing 10.

Hereinafter, for convenience of description, an extending direction of the drive axis TX is defined as the up-down direction of the grinder 100. In the up-down direction, the one end side of the spindle 30 to which the tip tool 91 is attached is defined as the lower side of the grinder 100, and the opposite side is defined as the upper side of the grinder 100. An extending direction of the rotation axis RX of the output shaft 21 is defined as the front-rear direction of the grinder 100. In the front-rear direction, the side on which the spindle 30 is disposed is defined as the front side of the grinder 100, and the opposite side is defined as the rear side of the grinder 100. A direction orthogonal to the up-down direction and the front-rear direction is defined as the left-right direction of the grinder 100.

As shown in FIG. 1, the housing 10 includes a motor housing 11, a gear housing 15 connected to the front end of the motor housing 11, the grip portion 18 connected to the rear end of the motor housing 11, and a controller housing 13 connected to the rear end of the grip portion 18.

As shown in FIG. 3, the controller housing 13 is formed in a cylindrical shape whose diameter increases toward the rear from the rear end of the grip portion 18. In other words, the controller housing 13 is configured such that the outer shape of a cross-section thereof orthogonal to the rotation axis RX becomes larger the further toward the rear from the grip portion 18. At the upper end portion of the controller housing 13, a dial 95 is held in a state in which an upper side section of the dial 95 is exposed to the outside. The dial 95 is configured as an operation device that receives a rotation operation by the user, and sets a rotational speed of the motor 20 in a stepless manner.

The controller housing 13 houses a controller 94. The controller 94 includes a circuit board on which are mounted a CPU as a processor controlling driving of the motor 20, storage devices such as a RAM, a ROM, and the like, and switching terminals and the like that operate based on control signals from the CPU. As a result of the CPU reading out and executing programs stored in a memory, the controller 94 executes various functions realized by the grinder 100 according to the present embodiment.

In the present embodiment, a battery attachment portion 132 with which the battery 93 can be slidingly engaged, is provided at the rear side of the controller housing 13. A power receiving terminal and the like that can be electrically connected to a power supply terminal of the battery 93 are provided in the battery attachment portion 132.

The motor housing 11 is a housing including a long cylindrical portion extending in the front-rear direction. As shown in FIG. 3, the motor housing 11 houses the motor 20. The output shaft 21 of the motor 20 extends in the front-rear direction. The front end portion and the rear end portion of the output shaft 21 are respectively supported by bearings. The front end portion of the output shaft 21 of the motor 20 protrudes into the gear housing 15, and a drive bevel gear 22 is fixed to the section of the output shaft 21 that protrudes into the gear housing 15.

As shown in FIG. 3, the gear housing 15 houses the spindle 30. The spindle 30 is a shaft having a long substantially circular pillar shape. The spindle 30 is disposed inside the gear housing 15 so as to extend in the up-down direction, and is supported by a plurality of bearings so as to be able to rotate around the drive axis TX. A driven bevel gear 32, which meshes with the drive bevel gear 22 of the output shaft 21, is fixed to the upper portion of the spindle 30.

The grip portion 18 is formed in a cylindrical shape having a substantially constant diameter, and extends in a straight line in the front-rear direction. The grip portion 18 is configured to be grippable by the user, and is configured to function as a so-called main handle. The grip portion 18 is formed to be narrower than the motor housing 11 and the controller housing 13, so as to be easily held by the user. As shown in FIG. 3, a switch 19 is provided inside the grip portion 18, and a paddle switch 14 configured to be manually operable by the user is provided at the lower end of the grip portion 18.

The switch 19 is a so-called mechanical switch. The switch 19 is disposed inside the housing 10 to the rear of the motor 20. The switch 19 is switched on and off in accordance with operation of the paddle switch 14. The motor 20 is driven during a period in which the switch 19 is further switched on in a state in which the grip portion 18 and the sub handle 60 are gripped. Note that the switch 19 may be configured as a microswitch.

The paddle switch 14 switches on and off the switch 19 provided inside the grip portion 18. Note that, instead of the paddle switch 14, the configuration may employ a switch knob that can be slidingly operated in the front-rear direction, a trigger switch, a snap switch, or the like.

The paddle switch 14 includes a pressing portion 142, a lock off lever 144, and a coil spring 146. The paddle switch 14 is urged toward the outside of the grip portion 18 by the coil spring 146, and is normally disposed at a stop position at which the motor 20 is stopped.

When the user presses the paddle switch 14 toward the inside of the grip portion 18 against the urging force of the coil spring 146, the paddle switch 14 is displaced to an activation position for activating the motor 20. At the activation position, the pressing portion 142 switches the switch 19 on by pressing in a plunger 192 of the switch 19.

The lock off lever 144 normally restricts the displacement of the paddle switch 14 to the activation position. The lock off lever 144 is configured to be rotatable, and allows the displacement of the paddle switch 144 to the activation position when rotated by a manual operation by the user.

The user attaches the tip tool 91 in accordance with the desired machining operation, grips the grip portion 18 and the sub handle 60, and switches the paddle switch 14 to the activation position. In this way, the switch 19 is turned on. The controller 94 starts the driving of the motor 20 in response to the switch 19 being turned on. Note that, as will be described later, in the grinder 100 according to the present embodiment, the controller 94 allows the driving of the motor 20 when the controller 94 detects that grip levers 624 of the sub handle 60 have been pressed, and also detects that the switch 19 has been turned on.

When the motor 20 is driven, the rotation of the output shaft 21 is transmitted to the spindle 30, and the spindle 30 is driven to rotate. As a result, the tip tool 91 fixed to the spindle 30 is driven to rotate in a specific rotation direction. Note that, in the present embodiment, the rotation direction of the spindle 30 is the clockwise direction in a plan view. The user can perform the machining operation using the grinder 100, by pressing the tip tool 91 against the workpiece. Note that the controller 94 can further set the rotation speed of the motor 20 based on a resistance value set via the dial 95.

### Configuration of sub handle 60

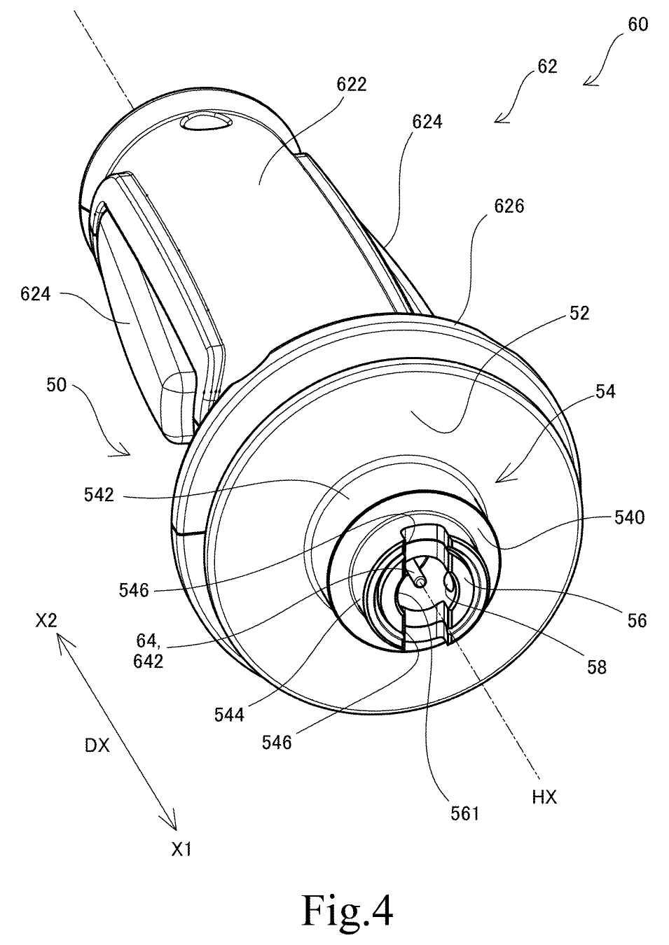

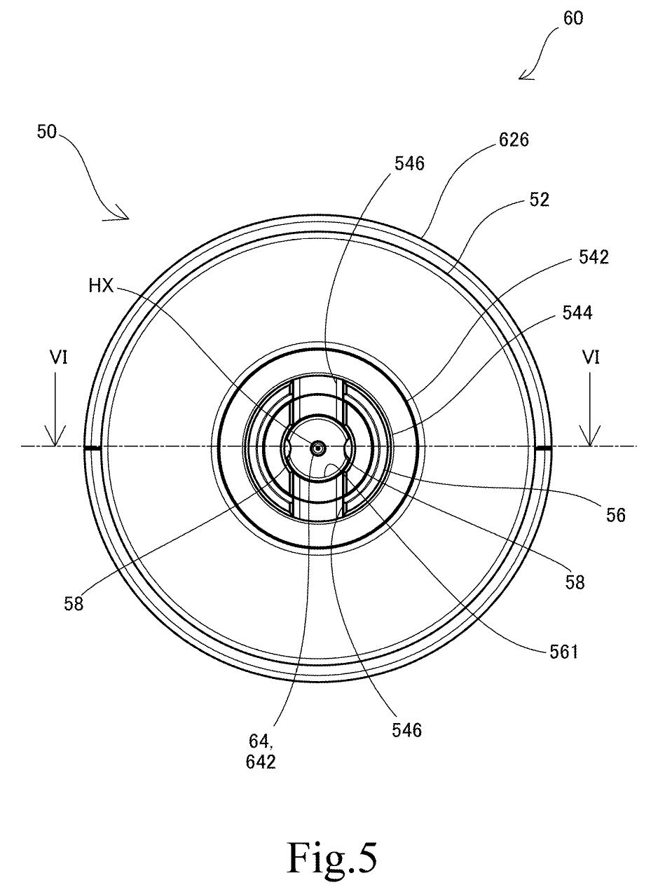

As shown in FIG. 4, the sub handle 60 extends in one direction and is configured to be grippable by the user. As shown in FIGS. 4 and 5, the sub handle 60 includes a main body 62, a shaft portion 64, and a fixing mechanism 50.

The main body 62 has a long substantially circular cylindrical shape that extends in the one direction. In the present embodiment, a long axis of the main body 62 and a center axis HX of the main body 62 are aligned. The “center axis HX of the main body 62” refers to a straight line based on a center of a cross-sectional shape of the main body 62. The “cross-sectional shape of the main body 62” refers to the outer shape of the main body 62 in a cross-section orthogonal to the extending direction of the main body 62. The “center of the cross-sectional shape” includes a centroid of the cross-sectional shape, or a center of gravity of the cross-sectional shape. In the present embodiment, the center of gravity of the cross-section of the main body 62 refers to the center of the cross-sectional shape of the main body 62. In the following description, as necessary, a direction corresponding to the center axis HX will be defined as an “axial direction DX” of the sub handle 60. In the axial direction DX, a side to which a handle attachment portions 16 are attached will be defined as an “axial direction inner side X1”, and the opposite side will be defined as an “axial direction outer side X2”.

As shown in FIG. 4, the main body 62 includes a grip portion 622, the grip levers 624, and a flange portion 626. The grip portion 622 is a section configured to be grippable by the user. The grip portion 622 is configured to have a thickness (outer diameter), length, and shape for easy gripping by the user. As will be described later, the grip levers 624 detect a state of the gripping of the grip portion 622 by the user. The flange portion 626 is a section having a larger diameter than that of the grip portion 622. The flange portion 626 protects the hands of the user gripping the grip portion 622.

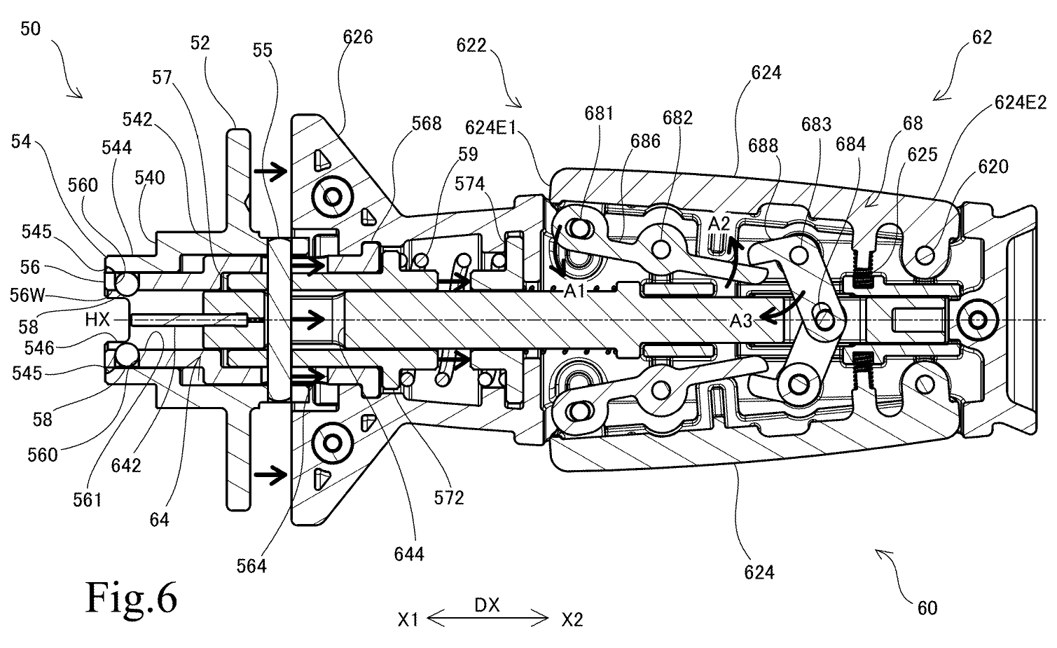

As shown in FIG. 6, the shaft portion 64 is a rod-shaped member extending in the axial direction DX. A pin 642 provided at the tip end of the shaft portion 64 on the axial direction inner side X1 is configured to be able to come into contact with a part of the detection unit 70 inside the housing 10. As a result of being in contact with the shaft portion 64, the detection unit 70 detects information relating to the sub handle 60. The “information relating to the sub handle 60” refers, for example, to information relating to (i) whether or not the sub handle 60 is being gripped by the user, (ii) whether or not the sub handle 60 is attached to the plurality of handle attachment portions 16, or (iii) to which handle attachment portion 16, of the plurality of handle attachment portions 16, is the sub handle 60 attached. In the present embodiment, the detection unit 70 acquires information relating to whether or not the sub handle 60 is being gripped by the user. Hereinafter, this function of the detection unit 70 will also be referred to as a “grip detection function”.

In the present embodiment, the shaft portion 64 operates in response to an operation of the grip levers 624, and the position of the shaft portion 64 is switched. Specifically, the arrangement of the shaft portion 64 is switched between a housed position at which the shaft portion 64 is housed in the main body 62, and a protruding position in which the shaft portion 64 protrudes from the main body 62 toward the handle attachment portions 16. The shaft portion 64 disposed at the protruding position comes into contact with the detection unit 70 inside the housing 10. The detection unit 70 performs the grip detection of the grip portion 622 as a result of the contact with the shaft portion 64.

As shown in FIG. 4, the fixing mechanism 50 is coupled to the sub handle 60, and the sub handle 60 can be attached to the handle attachment portion 16 by attaching the fixing mechanism 50 to the handle attachment portion 16. Further, by operating in response to an operation by the user, the fixing mechanism 50 can fix the sub handle 60 attached to the handle attachment portion 16. The fixing mechanism 50 includes an operation portion 52, an outer cylinder 54, an inner cylinder 56, fixing portions 58, and recess portions 546. The recess portions 546 are formed at the tip end on the axial direction inner side X1 of the fixing mechanism 50 (more specifically, are formed at the tip end of a small diameter portion 544 of the outer cylinder 54, and the tip end of the inner cylinder 56).

The operation portion 52 and the outer cylinder 54 form the outer contour of the fixing mechanism 50. The operation portion 52 is a so-called flange connected to the outer cylinder 54, and having a larger diameter than that of the outer cylinder 54. The operation portion 52 is configured to be able to switch, by a manual operation by the user, between a first position on the axial direction inner side X1, and a second position further to the axial direction outer side X2 than the first position. Note that, in FIGS. 4-6, the sub handle 60 is illustrated in a state in which the operation portion 52 is disposed at the first position.

When the operation portion 52 is disposed at the first position, the fixing mechanism 50 is switched to a fixing state in which the sub handle 60 attached to the handle attachment portion 16 can be fixed to the handle attachment portion 16. When the operation portion 52 is disposed at the second position, the fixing mechanism 50 is switched to a non-fixing state in which, in accordance with the outer cylinder 54 moving to the axial direction outer side X2, the sub handle 60 fixed to the handle attachment portion 16 can be removed from the handle attachment portion 16. Note that, in the grinder 100 according to the present embodiment, a configuration is adopted in which the sub handle 60 cannot be attached to the handle attachment portion 16 when the fixing mechanism 50 is in the fixing state.

The outer cylinder 54 includes a large diameter portion 542, the small diameter portion 544 whose outer diameter is smaller than that of the large diameter portion 542, and a first contact surface 540 connecting the large diameter portion 542 and the small diameter portion 544. The small diameter portion 544 has a substantially circular cylindrical shape, and is disposed at the tip end of the sub handle 60 on the axial direction inner side X1. As will be described later, the small diameter portion 544 functions as a first engagement portion that engages with a second engagement portion 162 formed in the handle attachment portion 16. As shown in FIG. 6, at the tip end of the small diameter portion 544 on the axial direction inner side X1, a recess portion 545 is formed in the inner surface of the small diameter portion 544. The recess portion 545 is configured to be able to receive a part of the fixing portions 58. The large diameter portion 542 is connected to the axial direction outer side X2 of the small diameter portion 544, and has a substantially circular cylindrical shape whose diameter is larger than that of the small diameter portion 544.

As shown in FIGS. 4 and 6, the inner cylinder 56 has a substantially circular cylindrical shape extending in the axial direction DX. The inner cylinder 56 holds the fixing portions 58. When the operation portion 52 is disposed at the second position, the fixing portions 58 are disposed at attaching positions at which the handle can be attached to the handle attachment portion 16. When the operation portion 52 is disposed at the first position, the fixing portions 58 are disposed at fixing positions at which the handle attached to the plurality of handle attachment portions 16 is fixed. At the tip end of the inner cylinder 56 on the axial direction inner side X1, a third engagement portion 561, which can receive a fourth engagement portion 167 to be described later, is defined on the inner side of the inner cylinder 56.

In the present embodiment, the fixing portions 58 are metal spherical bodies (balls). As shown in FIG. 6, the fixing portions 58 are held by holding portions 560. The holding portions 560 are penetrating holes penetrating the inner cylinder 56 in a radial direction (a thickness direction). As a result of the holding portions 560, the diameter of an opening formed in an inner surface 56W of the inner cylinder 56 is smaller than the diameter at the holding portions 560. Further, the diameter of each of the fixing portions 58 is configured to be larger than the thickness of the inner cylinder 56. As a result of this configuration, the inner cylinder 56 can hold the fixing portions 58, using the holding portions 560, in a state in which the fixing portions 58 protrude toward the center axis HX from the inner surface 56W.

As shown in FIG. 6, a pin 55 is fixed to a section of the large diameter portion 542 further to the axial direction outer side X2 than the operation portion 52. The pin 55 is a rod-shaped member disposed in direction orthogonal to the center axis HX. The pin 55 is inserted into a through hole 564 formed in the inner cylinder 56. The through hole 564 restricts a movement direction of the pin 55 to a predetermined range in the axial direction DX. As a result, the outer cylinder 54 and the operation portion 52 can move with respect to the inner cylinder 56 over a movement range corresponding to the movement range of the pin 55.

The pin 55 is inserted through a biasing cylinder 57, and is coupled to the outer cylinder 54 and the biasing cylinder 57 so as to be able to move integrally therewith. The pin 55 is inserted through a through hole 644 formed in the shaft portion 64. Thus, the operation portion 52, the outer cylinder 54, the pin 55, and the biasing cylinder 57 are configured to be able to move relative to the inner cylinder 56 inside the through hole 564, and to be able to move relative to the shaft portion 64 inside the through hole 644.

### Configuration of handle attachment portions 16

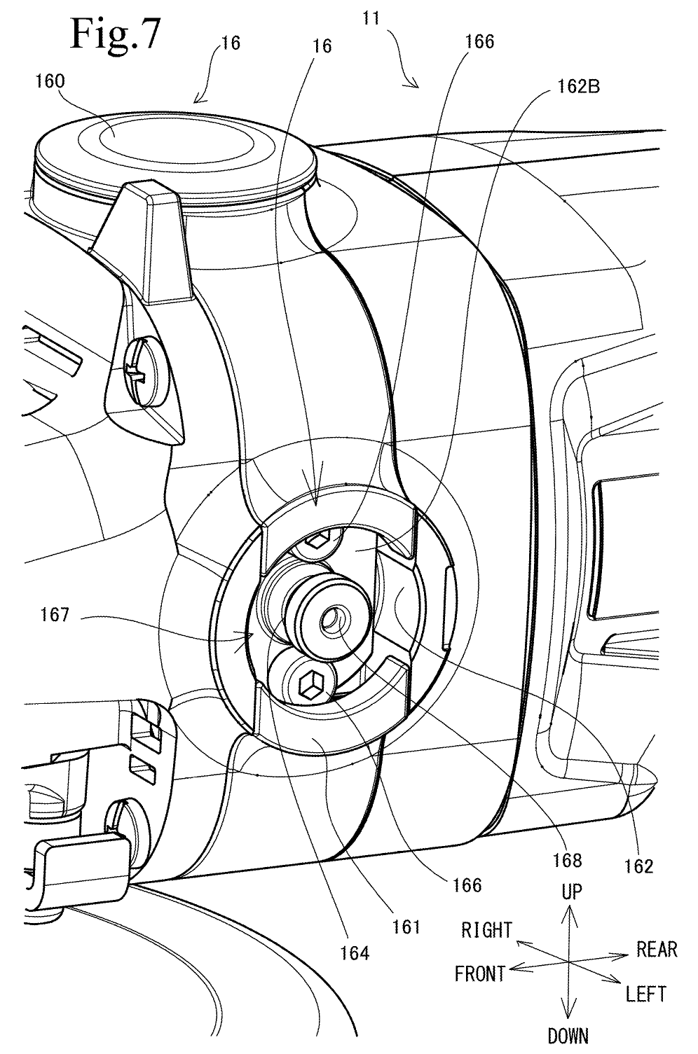

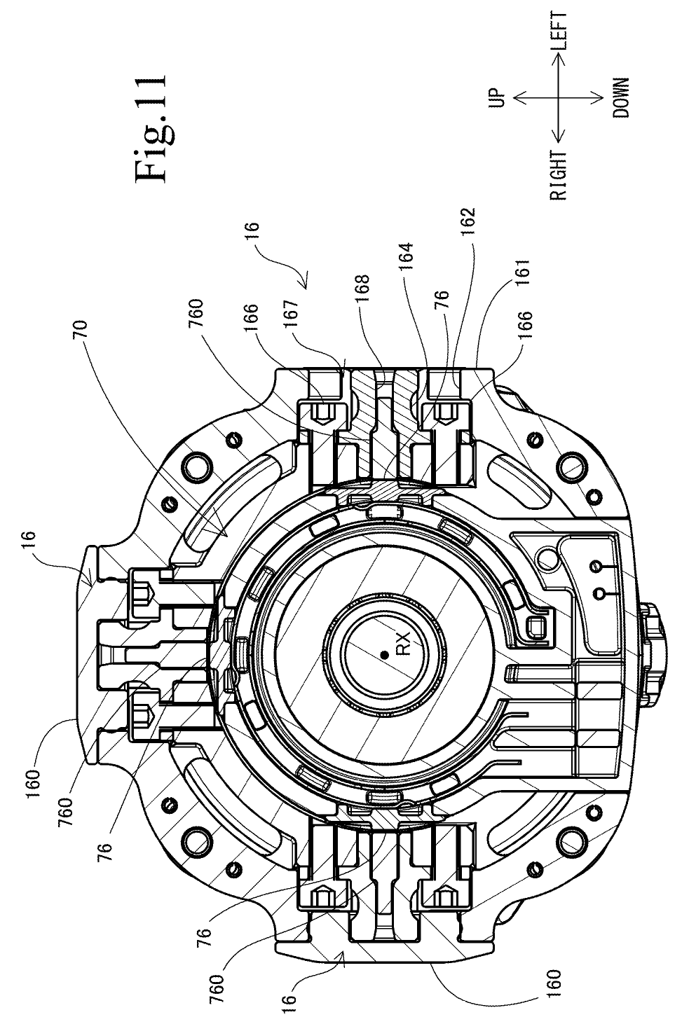

As shown in FIG. 7, the handle attachment portions 16 to which the sub handle 60 can be attached are formed at the housing 10. In the present embodiment, the handle attachment portions 16 are formed in the outer surface of the housing 10 in the vicinity of a border between the motor housing 11 and the gear housing 15. Note that, in the grinder 100 according to the present embodiment, three of the handle attachment portions 16 are formed at the right side, the left side, and the upper side of the housing 10 (refer to FIG. 11). As shown in FIG. 1, a resin cap 160 is attached to the handle attachment portion 16 to which the sub handle 60 is not attached. As a result of the cap 160 being attached, foreign material such as dust or the like generated by cutting by the grinder 100 can be prevented from entering into the handle attachment portion 16.

Depending on the type of the tip tool 91, in the power tool such as the grinder 100, the orientation and posture of the housing 10 when using the power tool are sometimes switched, such as a usage method in which the lower side of the housing 10 is disposed on the lower side in the vertical direction, a usage method in which the left side of the housing 10 is disposed on the lower side in the vertical direction, and the like. In this way, when the orientation of the power tool is switched by the user, from the point of view of improving convenience for the user, the position of the attachment of the sub handle 60 to the housing 10 can preferably be changed. In the grinder 100 according to the present embodiment, since the plurality of handle attachment portions 16 are provided on the housing 10, the configuration is obtained in which the attaching position of the sub handle 60 can be easily changed.

In the present embodiment, the three handle attachment portions 16 are respectively provided on the right side, the left side, and the upper side of the housing 10. In the present embodiment, the description is given using the example in which the sub handle 60 is coupled to the handle attachment portion 16 provided on the left side of the housing 10. Note that the number of the handle attachment portions 16 is not limited to only being three, and may be the single handle attachment portion 16, or may be any desired number, such as three or more.

As shown in FIG. 7, the handle attachment portion 16 includes a second contact surface 161, the second engagement portion 162, and the fourth engagement portion 167.

The second contact surface 161 is a section of the outer surface of the housing 10. The second contact surface 161 comes into contact with the first contact surface 540 of the sub handle 60 when the sub handle 60 is attached to the handle attachment portion 16.

The second engagement portion 162 is a recess portion formed in the second contact surface 161. As described above, the second engagement portion 162 is configured to be engageable with the small diameter portion 544 that is the first engagement portion.

The fourth engagement portion 167 is a protruding portion formed substantially at the center of a bottom surface 162B of the second engagement portion 162. The fourth engagement portion 167 protrudes from the bottom surface 162B toward the sub handle 60. The fourth engagement portion 167 is configured to be engageable with the third engagement portion 561 of the fixing mechanism 50. As a result of the engagement between the second engagement portion 162 and the small diameter portion 544, and the engagement between the fourth engagement portion 167 and the third engagement portion 561, the sub handle 60 is attached to the handle attachment portion 16.

An insertion hole 168 is formed at the tip end of the fourth engagement portion 167, and the pin 642 of the sub handle 60 can be inserted through the insertion hole 168. Further, a groove 164 is formed, extending in a circumferential direction, in the outer surface of the fourth engagement portion 167 around the center axis HX. As will be described later, the groove 164 is configured to be able to receive the fixing portion 58 provided at the tip end of the sub handle 60. As a result of the engagement between the groove 164 and the fixing portion 58, the inner cylinder 56 is latched together with the fourth engagement portion 167. As a result of this, the sub handle 60 attached to the handle attachment portion 16 is fixed to the handle attachment portion 16.

In the present embodiment, two protruding portions 166 are formed at the bottom surface 162B of the second engagement portion 162. In the present embodiment, the two protruding portions 166 are heads of bolts inserted through the bottom surface 162B. The two protruding portions 166 are disposed at the outer side in the radial direction of the fourth engagement portion 167. The two protruding portions 166 engage with the tip end on the axial direction inner side X1 of the fixing mechanism 50, that is, engage with the two recess portions 546 formed at the tip end of the sub handle 60. Thus, as a result of the engagement between the two recess portions 546 and the two protruding portions 166 around the fourth engagement portion 167, the sub handle 60 attached to the handle attachment portion 16 can be restricted from rotating around the fourth engagement portion 167.

### Attachment method and fixing method of sub handle 60

A method of attaching the sub handle 60 to the handle attachment portion 16 and a method of fixing the sub handle 60 to the handle attachment portion 16 will be described with reference to FIGS. 6, and 8 and 9. The fixing mechanism 50 switches the arrangement of the fixing portion 58 by switching the operation portion 52 between the first position and the second position. Utilizing the arrangement of the fixing portion 58, the sub handle 60 is switched between the state in which the sub handle 60 can be attached to or removed from the handle attachment portion 16, and the state in which the sub handle 60 can be fixed thereto.

The inner cylinder 56 is fixed to the interior of the flange portion 626 by a latching portion 568. In other words, the inner cylinder 56 cannot move with respect to the main body 62. The biasing cylinder 57 is disposed inside the inner cylinder 56 so as to be able to move relative to the inner cylinder 56.

As shown in FIG. 6, when the operation portion 52 is disposed at the first position, the tip end of the outer cylinder 54 is substantially flush with the tip end of the inner cylinder 56. At this time, the outer surface of the inner cylinder 56 is covered by the inner surface of the outer cylinder 54. Thus, the fixing portions 58 disposed in the holding portions 560 are restricted by the inner surface of the outer cylinder 54 from moving further to the outer side in the radial direction than the outer surface of the inner cylinder 56. As a result, the fixing portions 58 are held in the state of protruding further to the inner side in the radial direction than the inner surface 56W of the inner cylinder 56. At this time, in the fixing mechanism 50 in the fixing state, the tip end of the fourth engagement portion 167 is in contact with the fixing portions 58, and thus, the fourth engagement portion 167 is restricted from entering into the third engagement portion 561. Thus, in the state in which the operation portion 52 is disposed at the first position, the attachment of the sub handle 60 to the handle attachment portion 16 is restricted.

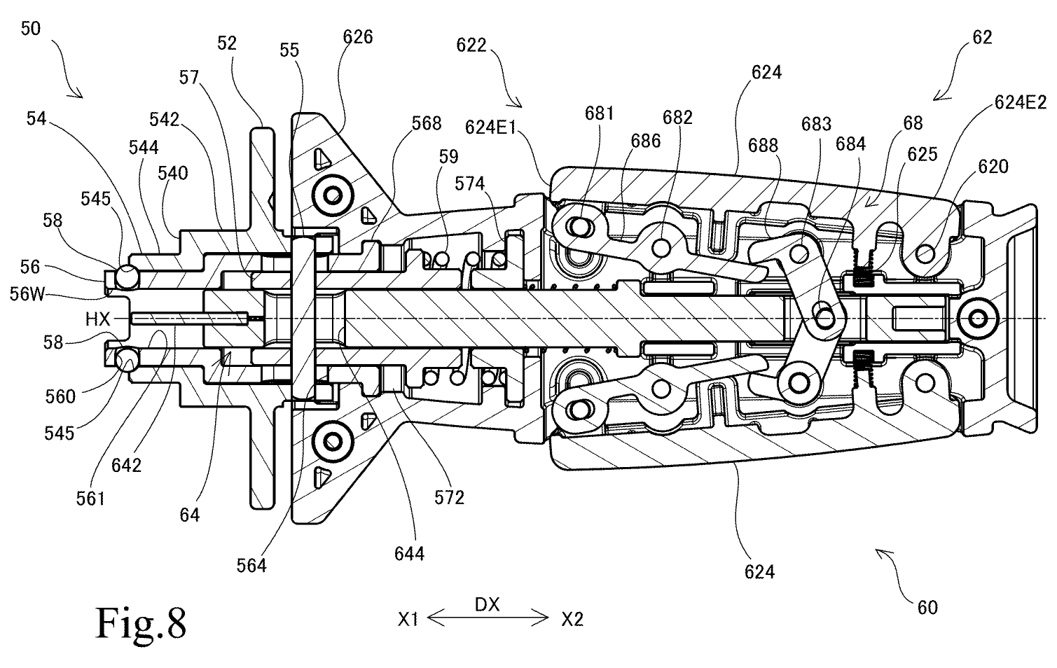

As shown in FIG. 8, when the operation portion 52 is moved to the axial direction outer side X2, the operation portion 52 is disposed at the second position. At this time, the recess portion 545 formed at the tip end of the small diameter portion 544 of the outer cylinder 54 is disposed to the outer side in the radial direction of the fixing portions 58. Thus, the fixing portions 58 disposed in the holding portions 560 can retract further to the outer side in the radial direction than the outer surface of the inner cylinder 56. At this time, the fourth engagement portion 167 becomes able to engage with the third engagement portion 561, and the fixing mechanism 50 is in the non-fixing state in which the sub handle 60 can be attached to the handle attachment portion 16, and in which the sub handle 60 fixed to the handle attachment portion 16 can be removed from the handle attachment portion 16.

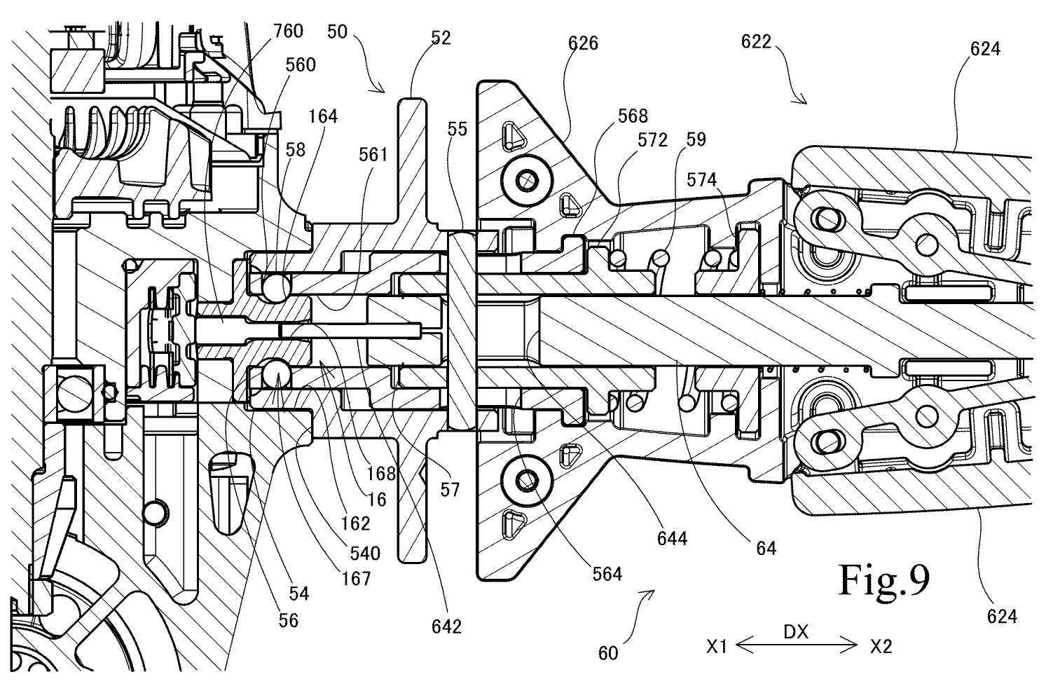

As shown in FIG. 9, when the fourth engagement portion 167 and the third engagement portion 561 are engaged with each other, the groove 164 of the fourth engagement portion 167 is disposed to the inner side in the radial direction of the fixing portions 58. When the operation portion 52 is moved to the axial direction inner side X1 in this state, the operation portion 52 is once more disposed at the first position. The movement of the fixing portions 58 further to the outer side in the radial direction than the outer surface of the inner cylinder 56 is restricted by the inner surface of the outer cylinder 54, and the fixing portions 58 are held in the state of protruding further to the inner side in the radial direction than the inner surface 56W of the inner cylinder 56. At this time, the fixing portions 58 engage with the groove 164 of the fourth engagement portion 167, and the fixing mechanism 50 is latched onto the handle attachment portion 16. In this way, in the state in which the sub handle 60 is attached to the handle attachment portion 16, and the operation portion 52 is disposed at the first position, the fixing state is obtained in which the sub handle 60 attached to the handle attachment portion 16 can be fixed to the handle attachment portion 16.

As shown in FIG. 6, a support portion 574 is provided inside the main body 62 of the sub handle 60. The support portion 574 is a so-called spring bearing, and a spring 59 that can extend and contract along the axial direction DX is disposed thereon. The spring 59 urges the biasing cylinder 57 toward the axial direction inner side X1.

The biasing cylinder 57 includes a flange 572 that protrudes toward the outer side in the radial direction further than other sections of the biasing cylinder 57. The spring 59 urges the flange 572 in a direction separating from the support portion 574. Thus, as shown in FIG. 6, due to the urging of the spring 59, the biasing cylinder 57 is disposed at a position separated from the support portion 574. In accordance with this, the operation portion 52 and the outer cylinder 54 are disposed at the first position of being separated furthest from the flange portion 626. In other words, due to the urging of the spring 59, the operation portion 52 is normally disposed at the first position. By adopting this type of configuration, the switching between the first position and the second position of the operation portion 52, and the switching of the fixing mechanism 50 between the fixing state and the non-fixing state can be easily executed.

### Configuration of grip detection mechanism

The grinder 100 according to the present embodiment is configured to be able to detect that the sub handle 60 attached to the handle attachment portion 16 is being gripped. Specifically, the detection unit 70 provided in the housing 10 detects when the grip portion 622 is gripped by the user and the grip levers 624 provided at the grip portion 622 are pressed. In response to the shaft portion 64 protruding from the sub handle 60 being pressed and thus the grip levers 624 being pressed, the detection unit 70 outputs a signal to the controller 94. The controller 94 detects that the sub handle 60 is being gripped based on the input of the signal.

As shown in FIGS. 4 and 6, the main body 62 of the sub handle 60 includes the two grip levers 624, and conversion mechanisms 68. The two grip levers 624 are provided at the grip portion 622 of the sub handle 60. The two grip levers 624 are coupled to the shaft portion 64 via the conversion mechanisms 68. Note that the grinder 100 according to the present embodiment includes, in the sub handle 60, the two conversion mechanisms 68 corresponding to the two grip levers 624. The two conversion mechanisms 68 have the same function, and thus, one of the conversion mechanisms 68 will be described below.

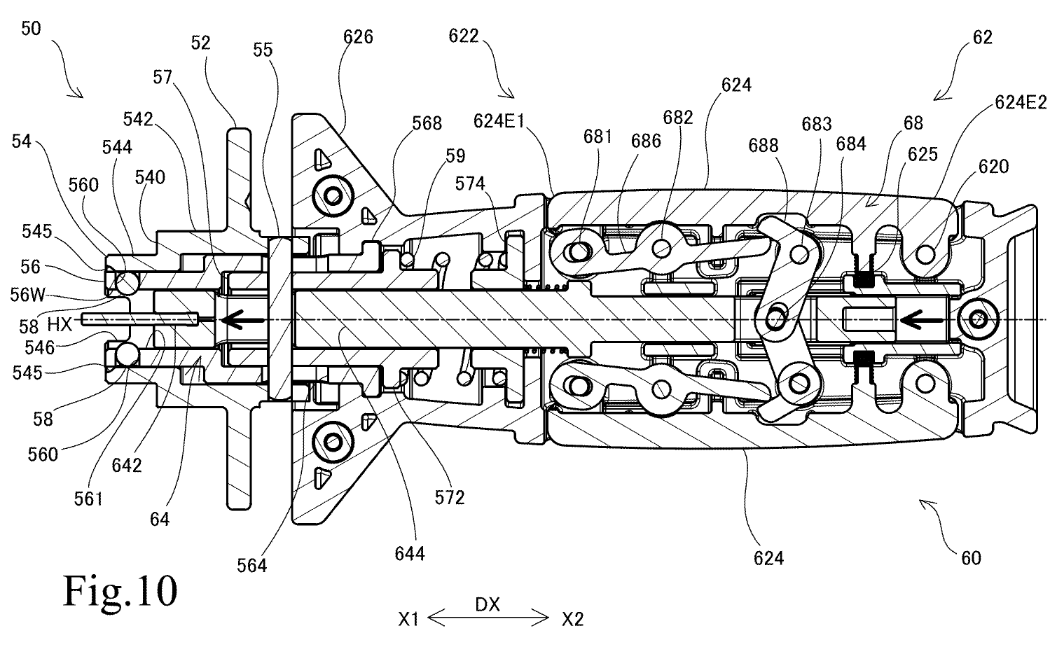

As shown in FIGS. 6 and 10, the conversion mechanism 68 converts the operation of the grip lever 624 into a linear movement of the shaft portion 64. In the present embodiment, when at least one of the grip levers 624, of the two grip levers 624, is pressed toward the center axis HX, a shaft portion 64 is moved toward the axial direction inner side X1 by the conversion mechanism 68, and the pin 642 protrudes from the tip end of the fixing mechanism 50.

As shown in FIG. 6, a lever shaft 620 is provided at an end portion 624E2 on the axial direction outer side X2 of the grip lever 624, and an end portion 624E1 on the axial direction inner side X1 of the grip lever 624 can rotate around the lever shaft 620. The grip lever 624 is urged toward the outer side in the radial direction by a spring 625 provided inside the main body 62. Thus, the end portion 624E1 of the grip lever 624 is normally in a state of protruding further to the outer side in the radial direction than the outer surface of the grip portion 622.

The end portion 624E1 on the axial direction inner side X1 of the grip lever 624 is coupled to the conversion mechanism 68. In the present embodiment, a link mechanism that is a booster mechanism is employed as the conversion mechanism 68, and the shaft portion 64 can be operated by pressing the grip lever 624 using a comparatively small amount of force. The conversion mechanism 68 includes a first link 686, a second link 688, a first shaft 681, a second shaft 682, a third shaft 683, and a fourth shaft 684. The conversion mechanism 68 is coupled to the shaft portion 64 via the fourth shaft 684. The second shaft 682 and the third shaft 683 are rotating shafts fixed to the inside of the grip portion 622.

The first shaft 681 is provided at the end portion 624E1 on the axial direction inner side X1 of the grip lever 624, and moves together with the end portion 624E1. The first link 686 is coupled to the end portion 624E1 via the first shaft 681. The first link 686 is a member that is long along the axial direction DX, and is configured to be able to rotate around the second shaft 682. The rotation of the first link 686 is transmitted to the second link 688.

The second link 688 is a member that is long in a direction intersecting the extending direction of the first link 686. The second link 688 is configured to be able to rotate around the third shaft 683. The fourth shaft 684 is provided at the tip end of the second link 688. The fourth shaft 684 is a rotating shaft formed at the shaft portion 64, and moves together with the movement of the shaft portion 64.

When the user grips the grip portion 622, and presses the grip lever 624, the grip lever 624 rotates around the lever shaft 620. As shown by an arrow A1 in FIG. 6, when the end portion 624E1 of the grip lever 624 is pressed down toward the center axis HX, the first link 686 rotates around the second shaft 682.

As shown by an arrow A2 in FIG. 6, when the first link 686 rotates around the second shaft 682, the tip end of the first link 686 comes into contact with the second link 688. The second link 688 rotates around the third shaft 683 as a result of the contact with the first link 686.

As shown by an arrow A3 in FIG. 6, when the second link 688 rotates around the third shaft 683, the fourth shaft 684 coupled to the tip end of the second link 688 moves toward the axial direction inner side X1 along the center axis HX. As a result, as shown in FIG. 10, the pin 624 at the tip end of the shaft portion 64 is disposed at the position protruding from the main body 62 toward the housing 10 (hereinafter also referred to as a “protruding position”). Note that, in the present embodiment, the above-described operation is realized by the operation of at least one of the two grip levers 624, and is also realized by the operation of both of the two grip levers 624.

### Configuration of detection unit 70

As shown in FIG. 11, the detection unit 70 is provided at the inner side in the radial direction of the three handle attachment portions 16. The detection unit 70 is configured to be able to detect the pin 642 of the shaft portion 64 protruding from the sub handle 60 disposed at the protruding position. Note that in FIG. 11, for ease of understanding, illustration of the sub handle 60 is omitted.

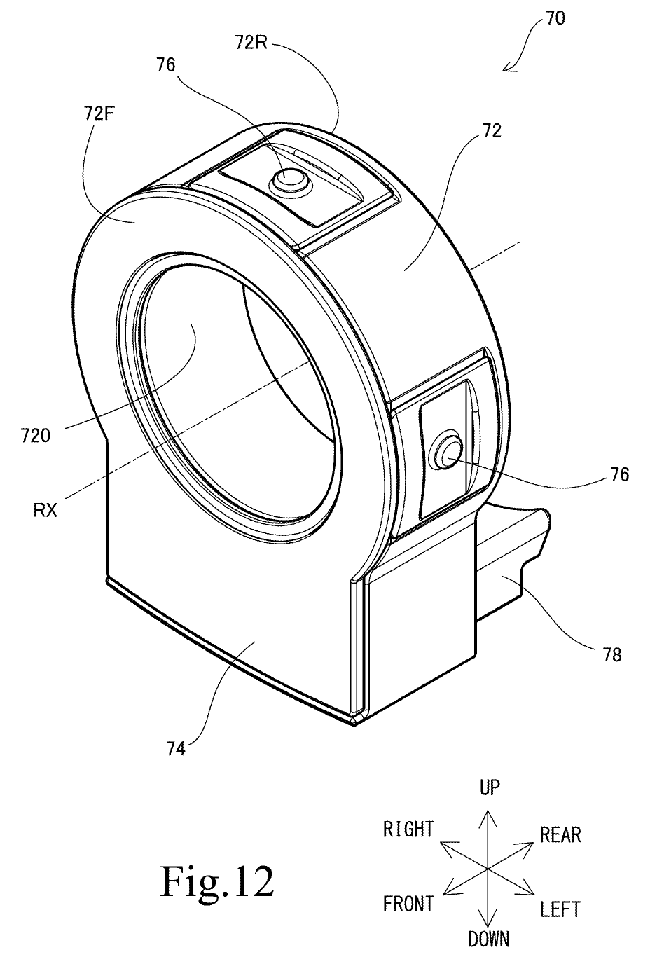

As shown in FIG. 12, the detection unit 70 includes a main body 72, a cover 74, a plurality of pressing portions 76, and a guide 78. A through hole 720, through which the output shaft 21 and the like can be inserted, is formed at substantially the center of the main body 72.

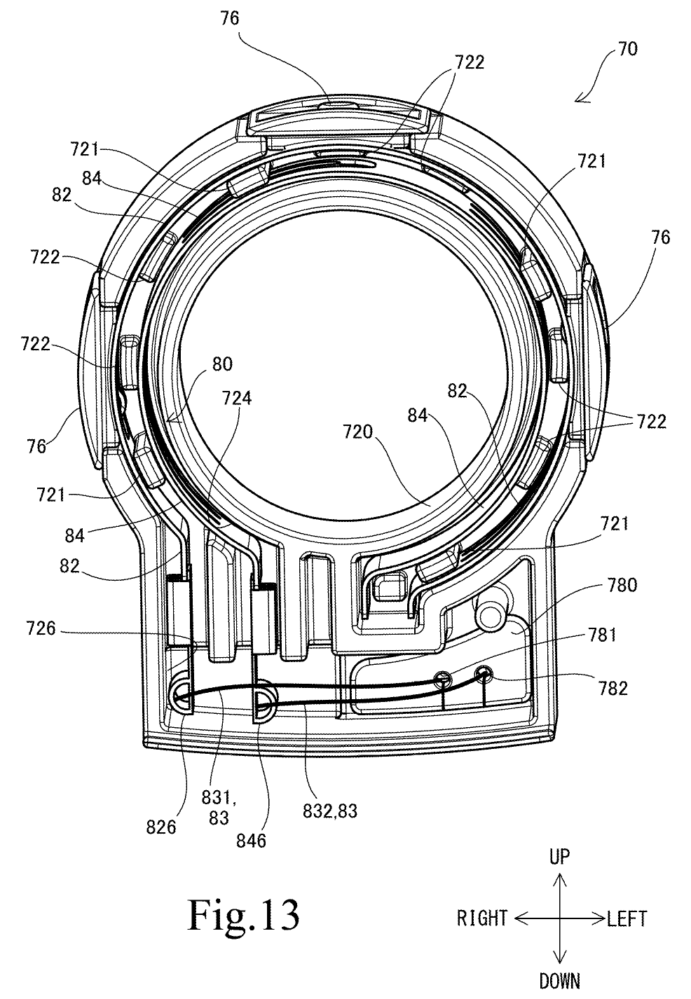

As shown in FIG. 13, the main body 72 is formed by an insulating material. A space for housing an electrode unit 80 is defined inside the main body 72. Specifically, two spaces that are an electrode housing portion 724, and a lead wire housing portion 726 are defined inside the main body 72, and are communicated with each other.

The electrode housing portion 724 extends in the circumferential direction to surround the rotation axis RX. An outer electrode 82 and an inner electrode 84 of the electrode unit 80 are housed in the electrode housing portion 724.

The lead wire housing portion 726 is defined below the electrode housing portion 724. The electrode housing portion 724 and the lead wire housing portion 726 are communicated with each other. A first terminal 826 and a second terminal 846 of the electrode unit 80 are disposed in the lead wire housing portion 726.

As shown in FIG. 12, the cover 74 is provided at a front surface 72F of the main body 72. The electrode housing portion 724 and the lead wire housing portion 726 are sealed by the cover 74, and foreign material and the like from the gear housing 15 is thus prevented from entering. Note that, in FIG. 13, the detection unit 70 is shown in a state in which the cover 74 is removed.

As shown in FIGS. 12 and 13, the plurality of pressing portions 76 are resin plungers. The plurality of pressing portions 76 are provided adjacent to the plurality of handle attachment portions 16 on the inner side thereof in the radial direction. Note that the plurality of pressing portions 76 prevent foreign material and the like from outside the detection unit 70 from entering into the electrode housing portion 724 and the lead wire housing portion 726 through the insertion hole 168 and the like.

The plurality of pressing portions 76 are pressed by the pin 642 disposed at the protruding position. In the grinder 100 according to the present embodiment, the plurality of pressing portions 76 are indirectly pressed by intermediate members 760 pressed by the pin 642 disposed at the protruding position. The plurality of pressing portions 76 may be directly pressed by the pin 642. The pressing portion 76 pressed by the pin 642 presses at least a part of the outer electrode 82, of the electrode unit 80.

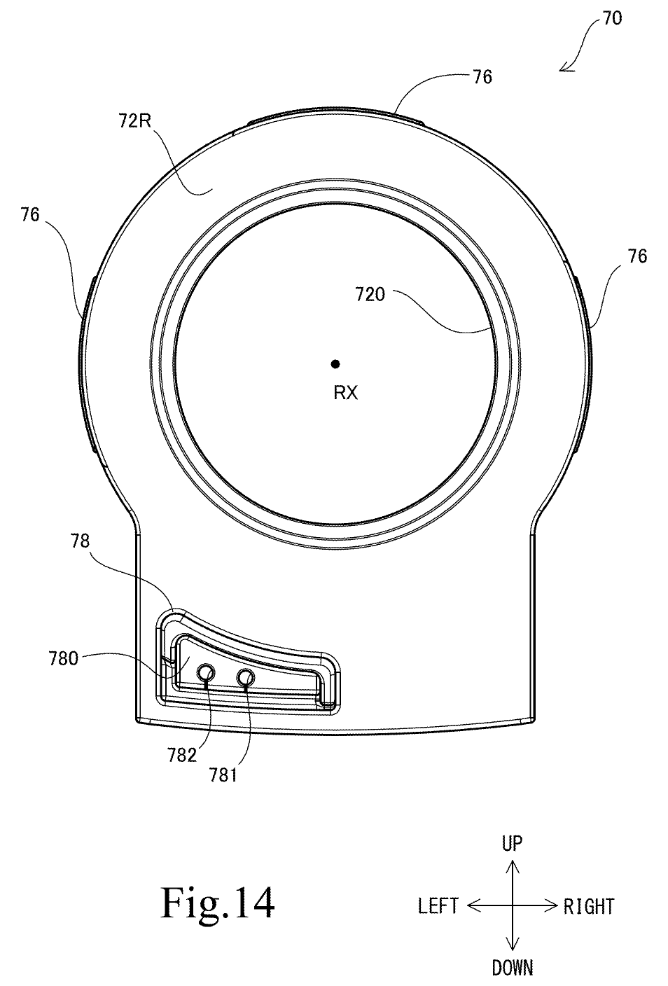

As shown in FIGS. 12 and 14, the guide 78 is provided at a rear surface 72R of the main body 72. As shown in FIG. 14, the guide 78 is formed in a cylindrical shape, and guides lead wires 83 disposed inside the main body 72 to the inside of the housing 10.

As shown in FIG. 14, of the rear surface 72R of the main body 72, a resin cover 780 is provided at a section connecting the guide 78 and the lead wire housing portion 726. The cover 780 prevents foreign material and the like from entering into the lead wire housing portion 726 from the motor housing 11.

As shown in FIGS. 13 and 14, a first through hole 781 and a second through hole 782 are formed in the cover 780. A first lead wire 831 that electrically connects the first terminal 826 and the controller 94 is inserted through the first through hole 781. A second lead wire 832 that electrically connects the second terminal 846 and the controller 94 is inserted through the second through hole 782. The first lead wire 831 and the second lead wire 832 are guided to the outside of the detection unit 70 from the lead wire housing portion 726 via the first through hole 781 and the second through hole 782, and are guided to the motor housing 11 via the guide 78. In the following description, when no distinction is made between the first lead wire 831 and the second lead wire 832, they are simply collectively referred to as the “lead wire 83”.

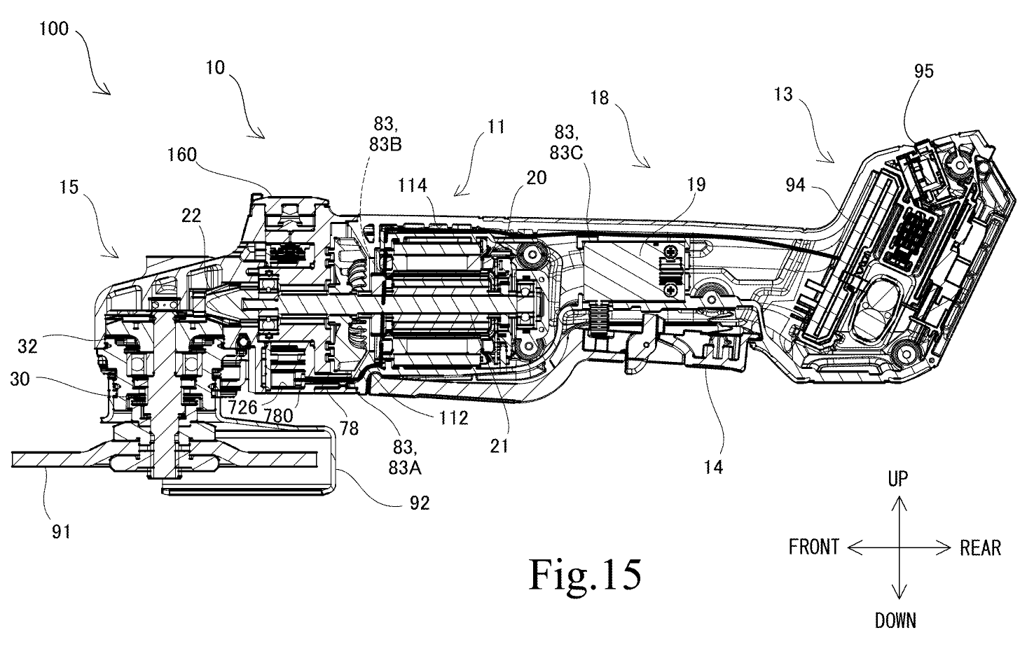

As shown by a lead wire 83A in FIG. 15, the lead wire 83 guided from the inside of the detection unit 70 to the rear of the detection unit 70 via the cover 780 is disposed in a through hole 112 formed in the lower end of the motor housing 11. As shown by a lead wire 83B in FIG. 15, the lead wire 83 disposed in the through hole 112 is guided toward a through hole 114 in the vicinity of the upper end of the motor housing 11, while detouring around the motor 20. In the present embodiment, guide members forming a wiring path detouring around the motor 20 are formed on the motor housing 11. By disposing the lead wire 83 on the wiring path, the lead wire 83 disposed around the motor 20 can be prevented from coming into contact with the motor 20.

The through hole 114 extends from the interior of the motor housing 11 to the interior of the grip portion 18. As shown by a lead wire 83C in FIG. 15, the lead wire 83 guided to the through hole 114 is guided to the interior of the grip portion 18 via the through hole 114, and is electrically connected to the controller 94 of the controller housing 13.

### Configuration of electrode unit 80

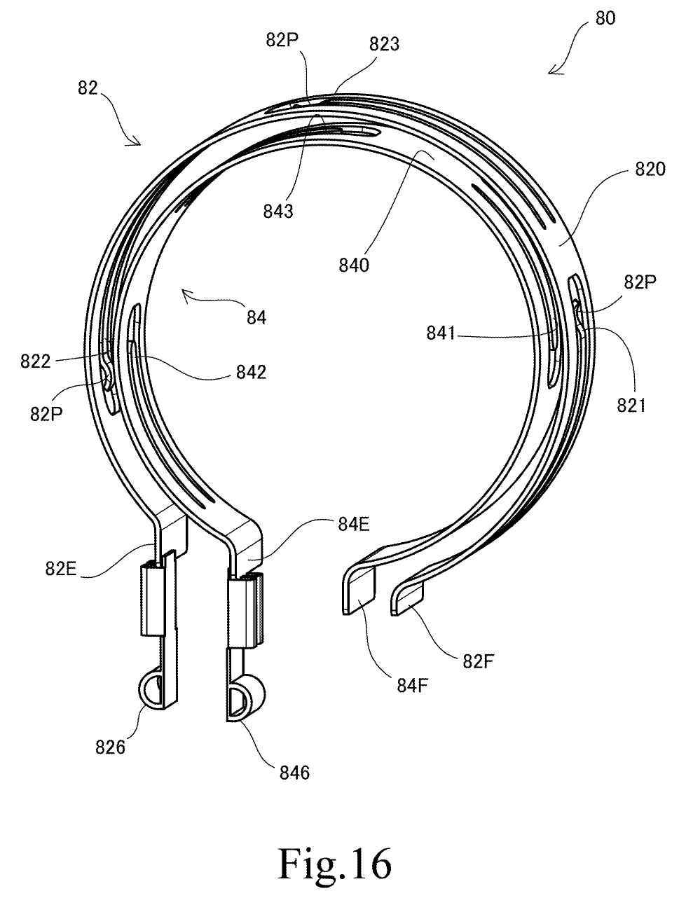

As shown in FIG. 16, the electrode unit 80 detects the pressing of the plurality of pressing portions 76 by the pin 642 by utilizing conductivity between the electrodes. The electrode unit 80 includes the outer electrode 82 and the inner electrode 84.

As shown in FIG. 16, the outer electrode 82 includes an outer main body 820, and the first terminal 826. The outer main body 820 is a metal plate extending in the circumferential direction. One end 82E of the outer main body 820 is connected to the first terminal 826. Another end 82F is fixed to the electrode housing portion 724 in order to restrict the outer electrode 82 from rotating with respect to the main body 72. In the present embodiment, an outer first elastic portion 821, an outer second elastic portion 822, and an outer third elastic portion 823 are formed at the outer main body 820.

The inner electrode 84 is disposed on the inner side in the radial direction of the outer electrode 82. The inner electrode 84 includes an inner main body 840, and the second terminal 846. The inner main body 840 is a metal plate extending in the circumferential direction. A width in the front-rear direction of the inner main body 840 is substantially the same as the width of the outer main body 820 in the front-rear direction. One end 84E of the inner main body 840 is connected to the second terminal 846. Another end 84F is fixed to the electrode housing portion 724 in order to restrict the inner electrode 84 from rotating with respect to the main body 72. In the present embodiment, an inner first elastic portion 841, an inner second elastic portion 842, and an inner third elastic portion 843 are formed at the inner main body 840.

As shown in FIG. 13, the outer electrode 82 and the inner electrode 84 are fixed to the electrode housing portion 724 of the detection unit 70 in a state, normally, of being separated from each other and being non-conductive. As shown in FIG. 13, a first restricting portion 721 and a second restricting portion 722 are formed in the electrode housing portion 724. The first restricting portion 721 and the second restricting portion 722 are formed between the outer electrode 82 and the inner electrode 84 in the electrode housing portion 724. The first restricting portion 721 and the second restricting portion 722 have a function as so-called spacers that restrict contact between the outer electrode 82 and the inner electrode 84. Further, the first restricting portion 721 restricts the inner first elastic portion 841, the inner second elastic portion 842, and the inner third elastic portion 843 from being displaced to the outer side in the radial direction. By adopting this type of configuration, it is possible to suppress or prevent a failure due to an electrical short-circuit between the outer electrode 82 and the inner electrode 84 as a result of the inner first elastic portion 841, the inner second elastic portion 842, and the inner third elastic portion 843 coming into contact with the outer electrode 82. Note that the widths of the first restricting portion 721 and the second restricting portion 722 in the front-rear direction (the heights) are mutually different. The second restriction portion 722 is configured to be lower than the first restricting portion 721, in order to avoid interference with the outer first elastic portion 821, the outer second elastic portion 822, and the outer third elastic portion 823.

As shown in FIG. 13, when a part of the outer electrode 82 comes into contact with a part of the inner electrode 84 via the pin 642 protruding from the sub handle 60, the outer electrode 82 and the inner electrode 84 are in a conductive state with each other. In the present embodiment, the outer electrode 82 and the inner electrode 84 are in the conductive state as a result of the outer first elastic portion 821 coming into contact with the inner first elastic portion 841.

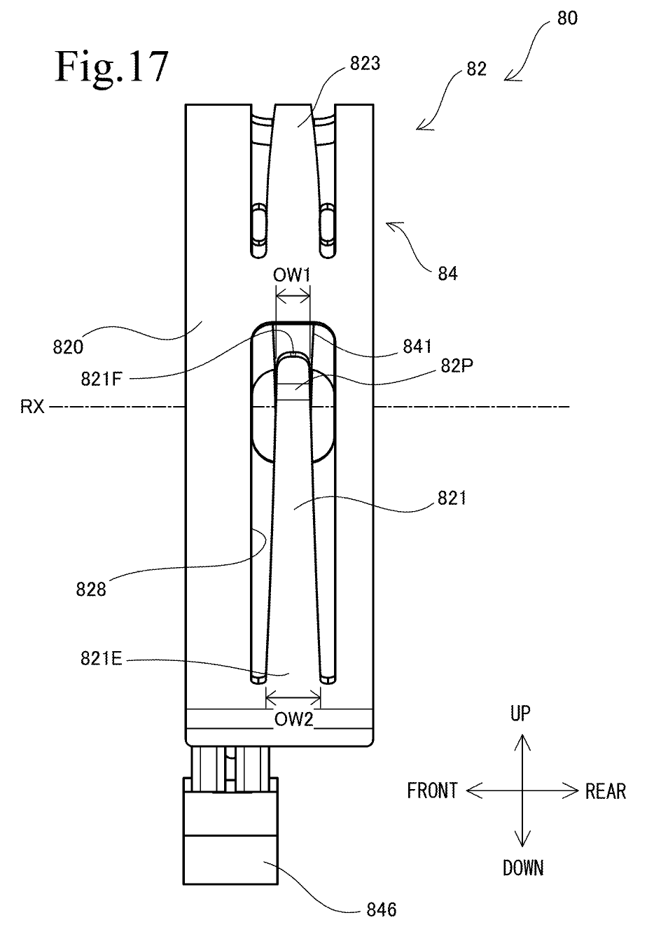

As shown in FIGS. 16 and 17, the outer first elastic portion 821 is a long plate extending in the circumferential direction. More specifically, when the electrode unit 80 is viewed from the front, the outer first elastic portion 821 extends, in an opening 828, in the counterclockwise direction from one end 821E. Note that the outer second elastic portion 822 and the outer third elastic portion 823 are configured in the same manner as the outer first elastic portion 821. Thus, in the following description, the outer first elastic portion 821 will be described as an example, and a description of the outer second elastic portion 822, and the outer third elastic portion 823 will be omitted.

As shown in FIG. 17, the outer first elastic portion 821 is provided in the long opening 828 formed in the circumferential direction in the outer main body 820. In the present embodiment, the outer first elastic portion 821 is formed by cutting out a part of the outer main body 820, and is formed integrally with the outer main body 820. The outer first elastic portion 821 has a lower modulus of elasticity than the outer main body 820 and is configured to be more easily bent than the outer main body 820. The one end 821E of the outer first elastic portion 821 is coupled to the outer main body 820, and is electrically connected to the outer main body 820. Another end 821F is a free end. Note that, as long as the outer first elastic portion 821 is electrically connected to the outer main body 820, the outer first elastic portion 821 may be configured separately from the outer main body 820.

As shown in FIG. 17, a protrusion 82P that protrudes toward the inner electrode 84 is formed on the other end 821F of the outer first elastic portion 821. The protrusion 82P is formed by bending a part of the other end 821F. The protrusion 82P functions as a contact point to electrically connect the outer first elastic portion 821 to the inner first elastic portion 841 of the inner electrode 84.

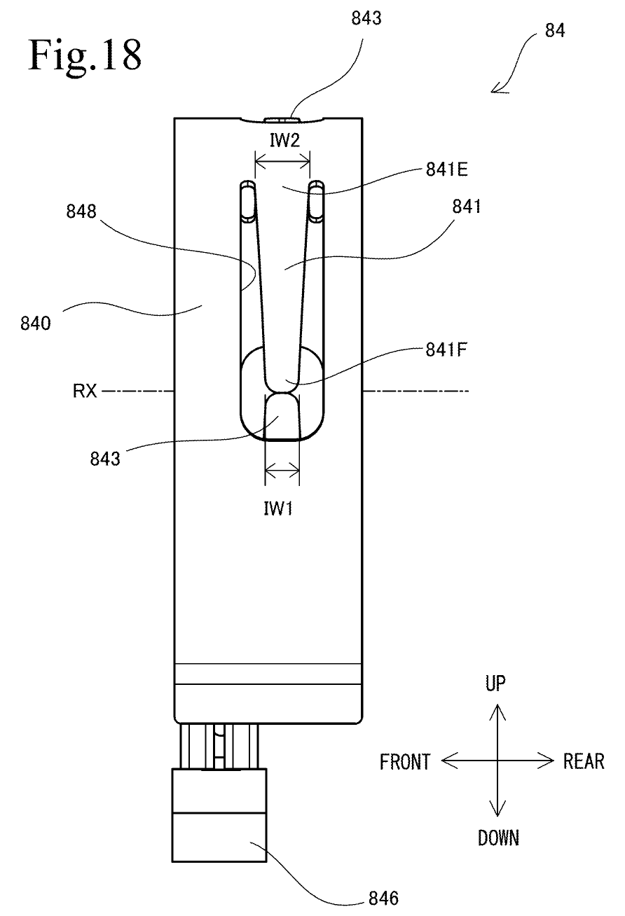

As shown in FIGS. 16 and 18, the inner first elastic portion 841 is a long plate extending in the circumferential direction. More specifically, when the electrode unit 80 is viewed from the front, the inner first elastic portion 841 extends, in an opening 848, in the clockwise direction from one end 841E. Note that the inner second elastic portion 842 and the inner third elastic portion 843 have the same function as the inner first elastic portion 841. Thus, in the following description, the inner first elastic portion 841 will be described as an example, and a description of the inner second elastic portion 842, and the inner third elastic portion 843 will be omitted.

As shown in FIG. 18, the inner first elastic portion 841 is provided in the long opening 848 formed in the circumferential direction in the inner main body 840. In the present embodiment, the inner first elastic portion 841 is formed by cutting out a part of the inner main body 840, and is formed integrally with the inner main body 840. The inner first elastic portion 841 has a lower modulus of elasticity than the inner main body 840 and is configured to be more easily bent than the inner main body 840. The one end 841E of the inner first elastic portion 841 is coupled to the inner main body 840, and is electrically connected to the inner main body 840. Another end 841F is a free end. Note that, as long as the inner first elastic portion 841 is electrically connected to the inner main body 840, the inner first elastic portion 841 may be configured separately from the inner main body 840.

As shown in FIG. 13, the outer first elastic portion 821 is provided at a position corresponding to the pressing portion 76 disposed on the left side, among the plurality of pressing portions 76. Further, as shown in FIG. 16, the outer first elastic portion 821 is provided at a position corresponding to the inner first elastic portion 841 of the inner electrode 84. In other words, the left side pressing portion 76, the outer first elastic portion 821, and the inner first elastic portion 841 are disposed in that order toward the inner side in the radial direction.

Normally, the outer first elastic portion 821 is configured to be flush with the surface of the outer main body 820. When the left side pressing portion 76 is pressed by the pin 642 of the sub handle 60, the pressing portion 76 presses the outer first elastic portion 821. The protrusion 82P of the pressed outer first elastic portion 821 moves toward the inner electrode 84 and comes into contact with the inner first elastic portion 841. As a result, the outer electrode 82 and the inner electrode 84 are electrically connected.

As shown in FIG. 17, in the outer first elastic portion 821, a width OW1 of the other end 821F in the front-rear direction is configured to be narrower than a width OW2 of the one end 821E in the front-rear direction. In other words, the width of the outer first elastic portion 821 is configured to taper toward the tip end thereof.

Here, for example, when the width OW1 of the other end 821F and the width OW2 of the one end 821E are the same as each other, that is, the width of the outer first elastic portion 821 is uniform from the one end 821E to the other end 821F, the displacement of the outer first elastic portion 821 at the one end 821E easily becomes larger than the displacement of the outer first elastic portion 821 in the vicinity of the pressed other end 821F. Thus, stress is easily concentrated at the one end 821E of the outer first elastic portion 821, and there is a possibility that the one end 821E may be easily damaged. In contrast to this, in the present embodiment, the width of the outer first elastic portion 821 is tapered toward the tip end thereof. In other words, a configuration is adopted in which, when the other end 821F is pressed, the displacement of the outer first elastic portion 821 at the other end 821F and the displacement of the outer first elastic portion 821 at the one end 821E are substantially the same as each other. Thus, the outer first elastic portion 821 can be substantially uniformly displaced over the entirety thereof. Thus, according to the present embodiment, compared to the case in which the width of the outer first elastic portion 821 is configured to be uniform from the one end 821E to the other end 821F, it is possible to significantly displace the outer first elastic portion 821 while suppressing or preventing damage of the one end 821E of the outer first elastic portion 821.

Further, by adopting the configuration in which the modulus of elasticity of the other end 821F is lower than the modulus of elasticity of the one end 821E, the outer first elastic portion 821 can be bent using the comparatively small pressing force. Thus, the outer first elastic portion 821 can be caused to come into contact with the inner first elastic portion 841 using the comparatively small pressing force. As a result, the detection unit 70 easily detects that the pin 642 is at the protruding position, and detection accuracy of the detection unit 70 can be improved.

As shown in FIG. 18, in the inner first elastic portion 841, a width IW1 of the other end 841F in the front-rear direction is configured to be narrower than a width IW2 of the one end 841E in the front-rear direction. In other words, the width of the inner first elastic portion 841 is configured to taper toward the tip end thereof. In other words, a configuration is adopted in which the displacement of the inner first elastic portion 841 at the other end 841F and the displacement of the inner first elastic portion 841 at the one end 841E are substantially the same as each other. Thus, the inner first elastic portion 841 can be substantially uniformly displaced over the entirety thereof. Thus, according to the present embodiment, compared to the case in which the width of the inner first elastic portion 841 is configured to be uniform from the one end 841E to the other end 841F, it is possible to significantly displace the inner first elastic portion 841 while suppressing or preventing damage of the one end 841E of the inner first elastic portion 841.

Further, by adopting the configuration in which the modulus of elasticity of the other end 841F is lower than the modulus of elasticity of the one end 841E, the inner first elastic portion 841 can be bent using the comparatively small pressing force. Thus, when the outer first elastic portion 821 is pressed and comes into contact with the inner first elastic portion 841, it is difficult for the outer first elastic portion 821 and the inner first elastic portion 841 to be separated. As a result, it is possible to suppress or prevent the occurrence of chattering at the contact point between the outer first elastic portion 821 and the inner first elastic portion 841.

In the grinder 100 according to the present embodiment, the configuration is adopted in which the extending direction of the outer first elastic portion 821 and the extending direction of the inner first elastic portion 841 are the reverse direction from each other. In other words, the vicinity of the one end 841E of the inner first elastic portion 841 and the outer first elastic portion 821 are disposed so as not to overlap in with each other in the radial direction. The first restricting portion 721 is disposed in the vicinity of the one end 841E of the inner first elastic portion 841. By adopting this type of configuration, the displacement of the outer first elastic portion 821 to the inner side in the radial direction is not restricted by the first restricting portion 721, and only the displacement of the inner first elastic portion 841 to the outer side in the radial direction can be suppressed by the first restricting portion 721.

As shown in FIG. 10, when the grip portion 622 of the sub handle 60 fixed to the handle attachment portion 16 is gripped by the user, the grip lever 624 is pressed. The pressing of the grip lever 624 is converted to the moving of the shaft portion 64 by the conversion mechanism 68. The shaft portion 64 is disposed at the protruding position, and the pin 642 protrudes from the sub handle 60.

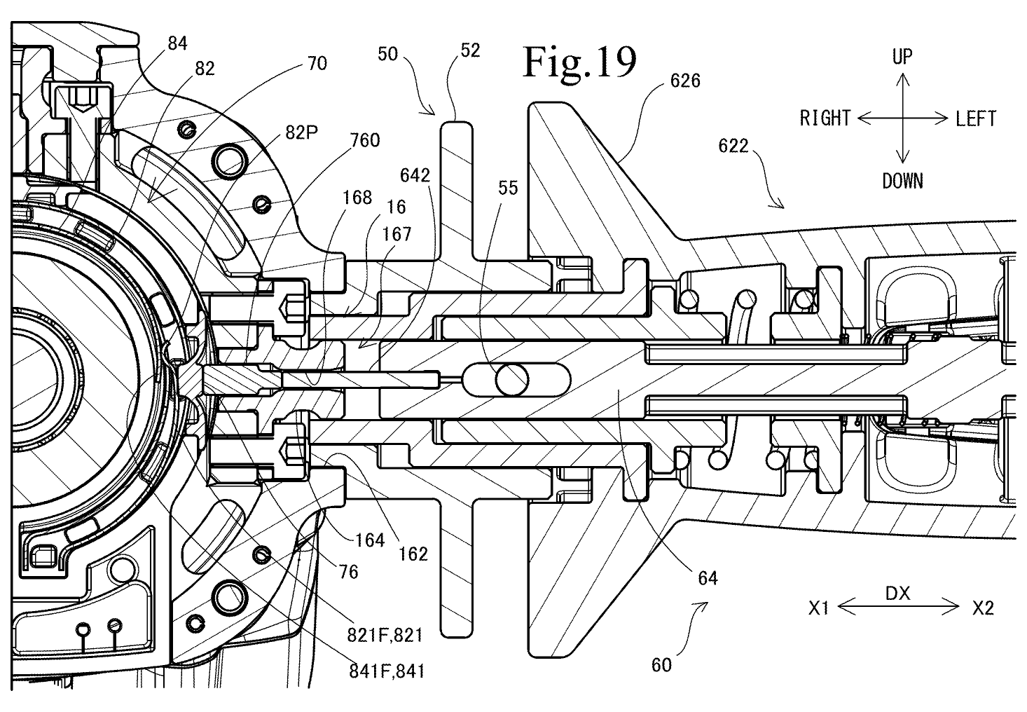

As shown in FIG. 19, the protruding pin 642 is inserted into the insertion hole 168 formed in the fourth engagement portion 167 of the handle attachment portion 16. The inserted pin 642 presses the intermediate member 760 disposed inside the handle attachment portion 16. The pressed intermediate member 760 presses the pressing portion 76, and the pressed pressing portion 76 presses the other end 821F of the outer first elastic portion 821. As a result of the pressing of the outer first elastic portion 821, the protrusion 82P comes into contact with the other end 841F of the inner first elastic portion 841. As a result, the outer electrode 82 and the inner electrode 84 are electrically connected, and the outer electrode 82 and the inner electrode 84 become conductive. The conductivity of the outer electrode 82 and the inner electrode 84 is output to the controller 94 as a signal, via the lead wire 83. The controller 94 detects the conductivity of the outer electrode 82 and the inner electrode 84 as the signal, and detects that the pin 642 is disposed at the protruding position, that is, detects that the grip portion 622 of the sub handle 60 is being gripped.

As described above, in the grinder 100 according to the present embodiment, the sub handle 60 includes the shaft portion 64 protruding toward the handle attachment portion 16, and the detection unit 70 that detects the protrusion of the shaft portion 64 is provided in the housing 10. The detection unit 70 is provided in the housing 10, and an electrical connection terminal that couples the sub handle 60 and the housing 10 is not provided at the handle attachment portion 16. Thus, it is possible to suppress or prevent the occurrence of an electrical connection failure when coupling the sub handle 60 and the housing 10, and information relating to the sub handle 60 can be appropriately detected.

According to the present embodiment, the sub handle 60 further includes the grip lever 624 pressed by the user gripping the grip portion 622, and the conversion mechanism 68 that converts the operation of the pressed grip lever 624 into the linear movement of the shaft portion 64. When the user is not gripping the grip portion 622, the shaft portion 64 is disposed at the housed position housed in the main body 62. When the user grips the grip portion 622, the shaft portion 64 is configured to be disposed at the protruding position, by the pressing detection portion and the conversion mechanism 68. The grinder 100 according to the present embodiment includes the structure for mechanically moving the pin 642 of the sub handle 60. Thus, the gripping of the sub handle 60 can be detected without electrically connecting the sub handle 60 and the housing 10. Thus, it is possible to prevent the occurrence of an electrical connection failure when coupling the sub handle 60 and the housing 10, and the gripping of the sub handle 60 can be appropriately detected.

According to the present embodiment, the detection unit 70 includes the electrode unit 80 including the inner electrode 84, and the outer electrode 82 disposed further to the outer side in the radial direction than the inner electrode 84 and disposed so as to surround the inner electrode 84. The detection unit 70 outputs the signal to the controller 94 in response to the outer first elastic portion 821 of the outer electrode 82 pressed by the pin 642 being electrically connected to the inner electrode 84. The detection unit 70 can be realized using a simple configuration, using the inner electrode 84 and the outer electrode 82.

According to the present embodiment, the outer electrode 82 includes the metal outer main body 820, and the outer first elastic portion 821 and the outer second elastic portion 822 made of metal and having elasticity connected to the outer main body 820. The outer first elastic portion 821 and the outer second elastic portion 822 are electrically connected to the inner electrode 84 when pressed by the shaft portion 64. By using elastic members having electrical conductivity as the detection portions of the detection unit 70, the outer electrode 82 and the inner electrode 84 are favorably switched between an electrically connected and non-connected state, and the detection accuracy by the detection unit 70 can be improved.

According to the present embodiment, the outer first elastic portion 821 is the long plate including the one end 821E connected to the outer main body 820, and the other end 821F that is pressed by the shaft portion 64. The width OW1 of the other end 821F of the outer first elastic portion 821 is configured to be narrower than the width OW2 of the one end 821E. Thus, the outer first elastic portion 821 can be substantially uniformly displaced over the entirety thereof when the other end 821F is pressed. Thus, compared to the case in which the width of the outer first elastic portion 821 is configured to be uniform from the one end 821E to the other end 821F, it is possible to significantly displace the outer first elastic portion 821 while suppressing or preventing damage of the one end 821E of the outer first elastic portion 821. Further, by adopting the configuration in which the modulus of elasticity of the section of the outer first elastic portion 821 that is pressed is lower than the modulus of elasticity of other sections, it is possible to cause the pressed section of the outer first elastic portion 821 to come into contact with the inner electrode 84 using the small pressing force. Thus, the detection result relating to the sub handle 60 is easily acquired and the detection accuracy of the detection unit 70 can be improved.

According to the present embodiment, the inner electrode 84 includes the metal inner main body 840, and the inner first elastic portion 8441 and the inner second elastic portion 842 made of metal and having elasticity connected to the inner main body 840. The inner first elastic portion 841 and the inner second elastic portion 842 are disposed at positions corresponding to the outer first elastic portion 821 and the outer second elastic portion 822, and are electrically connected to the outer first elastic portion 821 and the outer second elastic portion 822 pressed by the shaft portion 64. By using elastic members as the sections coming into contact with the outer first elastic portion 821 and the outer second elastic portion 822, when the outer first elastic portion 821 and the outer second elastic portion 822 are pressed and come into contact with the inner first elastic portion 841 and the inner second elastic portion 842, it is difficult for the outer first elastic portion 821 and the outer second elastic portion 822 to be separated from and the inner first elastic portion 841 and the inner second elastic portion 842. As a result, it is possible to suppress or prevent the occurrence of chattering at the contact points between the outer first elastic portion 821 and the outer second elastic portion 822, and the inner first elastic portion 841 and the inner second elastic portion 842.

According to the present embodiment, the inner first elastic portion 841 is the long plate including the one end 841E connected to the inner main body 840, and the other end 841F that is electrically connected to the outer first elastic portion 821. The width IW1 of the other end 841F of the inner first elastic portion 841 is configured to be narrower than the width IW2 of the one end 821E. Thus, the inner first elastic portion 841 can be substantially uniformly displaced over the entirety thereof when the other end 841F is pressed. Thus, compared to the case in which the width of the inner first elastic portion 841 is configured to be uniform from the one end 841E to the other end 841F, it is possible to significantly displace the inner first elastic portion 841 while suppressing or preventing damage of the one end 841E of the inner first elastic portion 841. Further, by adopting the configuration in which the modulus of elasticity of the other end 841F to be lower than the modulus of elasticity of the one end 841E, it is possible to bend the inner first elastic portion 841 using the comparatively small pressing force. Thus, in the state of being pressed by the outer first elastic portion 821, the inner first elastic portion 841 is not easily separated from the outer first elastic portion 821, and it is possible to suppress or prevent the occurrence of chattering at the contact point between the outer first elastic portion 821 and the inner first elastic portion 841.

According to the present embodiment, the first restricting portion 721 and the second restricting portion 727 that restrict the contact between the outer electrode 82 and the inner electrode 84 are disposed between the outer electrode 82 and the inner electrode 84. By disposed the so-called spacers between the outer electrode 82 and the inner electrode 84, it is possible to suppress or prevent a failure due to an electrical short-circuit between the outer electrode 82 and the inner electrode 84.

According to the present embodiment, the sub handle 60 further includes the fixing mechanism 50 that can switch between the fixing state in which the sub handle 60 attached to the plurality of handle attachment portions 16 can be fixed, or the non-fixing state in which the sub handle 60 attached to the plurality of handle attachment portions 16 can be removed from the plurality of handle attachment portions 16. The fixing mechanism 50 includes the operation portion 52 that is configured to be able to be switched between the first position and the second position closer to a main body portion than the first position, and the fixing portions 58. When the operation portion 52 is disposed at the second position, the fixing portions 58 are disposed at the attaching positions at which the sub handle 60 can be attached to the plurality of handle attachment portions 16, and when the operation portion 52 is disposed at the first position, the fixing portions 58 are disposed at the fixing positions at which the sub handle 60 attached to the plurality of handle attachment portions 16 is fixed. The sub handle 60 can be attached to and removed from the handle attachment portion 16 by the simple method of operating the operation portion 52. Thus, the grinder 100 can be provided in which the attachment and removal of the sub handle 60 is easy.

According to the present embodiment, the fixing mechanism 50 further includes the spring 59 that urges the operation portion 52 from the second position toward the first position. By utilizing the urging force of the spring 59, the operation portion 52 can be easily switched between the first position and the second position. Thus, the grinder 100 can be provided in which the attachment and removal of the sub handle 60 is easy.

According to the present embodiment, the fixing mechanism 50 further includes the outer cylinder 54 configured to move in parallel to the extending direction of the shaft portion 64, and the inner cylinder 56 housed in the outer cylinder 54. The inner cylinder 56 includes the holding portions 560 that movably hold the fixing portions 58. The inner cylinder 56 is configured to be able to internally receive the plurality of handle attachment portions 16. At the fixing positions, the movement of the fixing portions 58 to the outer side in the radial direction is restricted by the outer cylinder 54, and the fixing portions 58 protrude to the inside of the inner cylinder 56 and engage with the plurality of handle attachment portions 16 received inside the inner cylinder 56. At the attaching positions, the fixing portions 58 are configured to retract further to the outer side in the radial direction than the inner surface 56W of the inner cylinder 56, and not to engage with the plurality of handle attachment portions 16 received inside the inner cylinder 56. The arrangement of the fixing portions 58 can be switched by the simple configuration using the inner cylinder 56 and the outer cylinder 54.

According to the present embodiment, the shaft portion 64 is disposed further to the inner side in the radial direction than the outer cylinder 54 and the inner cylinder 56, and is configured to be movable with respect to the outer cylinder 54 and the inner cylinder 56. Thus, the grinder 100 having a rational structure can be provided in which the attachment and removal of the sub handle 60 is easy, and in which the shaft portion 64 is efficiently arranged.

A correspondence between each of structural elements (features) of the above-described embodiment and each of structural elements (features) of the present disclosure or the invention is as described below. Note that each of the structural elements of the embodiment is merely an example, and is not intended to limit each of the structural elements of the present disclosure or the invention.

The grinder 100 is an example of a “power tool”. The rotation axis RX is an example of a “motor rotation axis”. The output shaft 21 and the motor 20 are an example of an “output shaft” and a “motor”. The plurality of handle attachment portions 16 are an example of “a plurality of handle attachment portions”. The housing 10 is an example of a “housing”. The sub handle 60 is an example of a “handle”. The controller 90 is an example of a “controller”. The grip portion 622 and the main body 62 are an example of a “grip portion” and a “main body portion”. The shaft portion 64 and the pin 642 are an example of a “shaft portion”. The outer first elastic portion 821, the outer second elastic portion 822, and the outer third elastic portion 823 are an example of “a plurality of detection portions”. The detection unit 70 is an example of a “detection mechanism”. The grip lever 624 is an example of a “pressing detection portion”, and the conversion mechanism 68 is an example of a “conversion mechanism”. The inner electrode 84 and the outer electrode 82 are an example of an “inner electrode” and an “outer electrode”. The outer main body 820 is an example of an “outer main body portion”, and the outer first elastic portion 821 and the outer second elastic portion 822 are an example of an “outer first elastic portion” and an “outer second elastic portion”. The one end 821E and the other end 821F are an example of a “one end portion” and “another end portion”. The width OW1 and the width OW2 are an example of a “width of the other end portion” and a “width of the one end portion”. The inner main body 840 is an example of an “inner main body portion”, and the inner first elastic portion 841 and the inner second elastic portion 842 are an example of an “inner first elastic portion” and an “inner second elastic portion”. The one end 841E and the other end 841F are an example of the “one end portion” and “the other end portion”. The width IW1 and the width IW2 are an example of the “width of the other end portion” and the “width of the one end portion”. The first restricting portion 721 and the second restricting portion 722 are an example of a “restricting portion”. The fixing mechanism 50 is an example of a “fixing mechanism”. The operation portion 52 is an example of an “operation portion”, and the fixing portion 58 is an example of a “fixing portion”. The spring 59 is an example of an “urging member”. The outer cylinder 54 and the inner cylinder 56 are an example of an “outer cylinder” and an “inner cylinder”. The holding portion 560 is an example of a “holding portion”.

### Other embodiments

The power tool according to the present disclosure is not limited to the grinder 100 of the above embodiment. For example, changes exemplified below in a non-limiting manner are possible. Further, at least one of those changes can be adopted in combination with at least one of the grinder 100 of the embodiment, and the features described in the claims.

(B1) In the above-described first embodiment, the example is shown in which the grinder 100 includes the gripping detection mechanism including the grip lever 624, the conversion mechanism 68, and the shaft portion 64. In contrast, instead of the gripping detection mechanism, the grinder 100 may include a detection mechanism other than the gripping detection mechanism, such as a detection mechanism that detects whether or not the sub handle 60 is attached to the plurality of handle attachment portions 16, or a detection mechanism that detects to which of the handle attachment portions 16, of the plurality of handle attachment portions 16, the sub handle 60 is attached. In this case, the sub handle 60 need not necessarily include the conversion mechanism 68, and the pin 642 of the shaft portion 64 may be normally disposed at the protruding position.

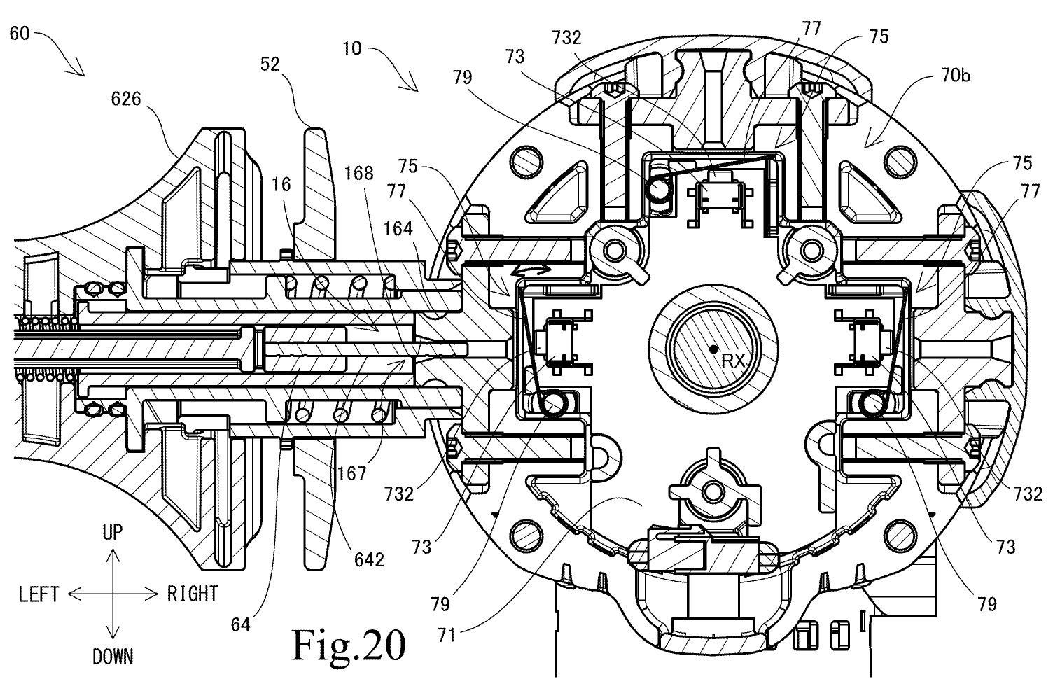

(B2) In the above-described first embodiment, the example is shown in which the detection unit 70 includes the electrode unit 80 including the outer electrode 82 and the inner electrode 84, and includes the outer first elastic portion 821, the outer second elastic portion 822, and the outer third elastic portion 823 at the positions corresponding to the plurality of handle attachment portions 16. In contrast, as in a detection unit 70b shown in FIG. 20, a plurality of switch units 75 may be provided that include a tactile switch 73. In the above-described first embodiment, whether or not the sub handle 60 is being gripped by the user is detected as a result of the pressing portion 76 being pressed by the pin 642, and a part of the outer electrode 82 of the electrode unit 80 coming into contact with a part of the inner electrode 84, thus causing the outer electrode 82 and the inner electrode 84 to become conductive. In contrast, in the example shown in FIG. 20, the gripping of the sub handle 60 is detected as a result of the tactile switch 73 being turned on by the pin 642.

Note that, in FIG. 20, a cross-sectional view is shown in which, in the front-rear direction, the positions at which the handle attachment portions 16 are provided at the housing 10 are seen from the rear.

As shown in FIG. 20, the detection unit 70b includes a circuit board 71, and the plurality of switch units 75 mounted to the circuit board 71. The circuit board 71 is electrically connected to the controller 94 via a lead wire (not shown in the drawings). The circuit board 71 extends in directions orthogonal to the rotation axis RX (in the up-down direction and in the left-right direction in the example in FIG. 20), and is disposed over the whole of a space inside the housing 10. The circuit board 71 is disposed over a wide range inside the housing 10, and thus, lead wires that electrically connect various loads, such as the plurality of switch units 75, the controller 94, a lighting unit and the like, can be reduced. As a result, the configuration inside the housing 10 can be simplified.

Each of the plurality of switch units 75 includes the tactile switch 73, a plate portion 77, and a shaft portion 79. The tactile switch 73 includes a plunger 732. The plate portion 77 is disposed between the plunger 732 and the insertion hole 168 of the fourth engagement portion 167, and is configured to rotate around the shaft portion 79. More specifically, as shown by arrows in FIG. 20, the plate portion 77 moves reciprocally between a position of pressing down the plunger 732, and a position in contact with the inner surface of the housing 10. The plate portion 77 is normally separated from the plunger 732, and the tactile switch 73 is normally turned off.

When the pin 642 enters into the housing 10 from the insertion hole 168 of the fourth engagement portion 167 as a result of the user gripping the sub handle 60, the pin 642 presses the plate portion 77 and the pressed plate portion 77 presses down the plunger 732. When the plunger 732 is pressed down, the tactile switch 73 is turned on, and power is supplied to the controller 94 via the circuit board 71 and the lead wire (not shown in the drawings). The power supplied to the controller 94 allows the driving of the motor 20.

In this way, even when the detection unit 70b is provided instead of the detection unit 70, the same effects as those of the above first embodiment can be achieved. The detection unit 70b is an example of the “detection mechanism”. The plurality of switch units 75 are an example of the “plurality of detection portions”. Note that, as in the example in FIG. 20, the intermediate member 760 inside the insertion hole 168 may be omitted. In this case, the number of components inside the housing 10 can be reduced.

Further, the detection unit 70b is not limited to the tactile switch 73, and various press button type switches may be provided. In addition to the tactile switch 73, the press button type switch includes a push momentary switch, a locker switch (also referred to as a seesaw switch), a membrane switch and the like. The press button type switch is turned on and off by being pressed by the pin 642 of the shaft portion 64, and the switching between on and off is output to the controller 94 via the circuit board 71. Note that the plurality of press button type switches may be connected in parallel by a plurality of lead wires, instead of the circuit board 71.

(B3) In the above-described first embodiment, the example is shown in which the three handle attachment portions 16 are provided at the right side, the left side, and the upper side of the housing 10. In contrast, the plurality of handle attachment portions 16 are not limited to the case of being the three handle attachment portions 16. The housing 10 may include a desired number of two or more of the handle attachment portions 16 on the right side and the left side, or the like, of the housing 10, for example. In this case, the number of members, such as the pressing portions 76, the outer first elastic portion 821, the inner first elastic portion 841 and the like are preferably the same as the number of the handle attachment portions 16.

(B4) In the above-described first embodiment, the example is shown in which the intermediate member 760 and the pressing portions 76 pressed by the intermediate member 760 are provided, and the pin 642 indirectly presses the outer first elastic portion 821 via the intermediate member 760 and the pressing portions 76. In contrast, at least one of the intermediate member 760 and the pressing portions 76 may be omitted. When both the intermediate member 760 and the pressing portions 76 are not provided, the pin 642 may directly press the outer first elastic portion 821.

(B5) In the above-described first embodiment, the example is shown in which the sub handle 60 is connected to the handle attachment portion 16 with the orientation in which the axial direction DX is orthogonal to the rotation axis RX. In contrast, the sub handle 60 may be attached to the handle attachment portion 16 with an orientation in which the axial direction DX is inclined at a predetermined angle with respect to the rotation axis RX.

(B6) In the above-described first embodiment, the example is shown in which the sub handle 60 includes the two grip levers 624. In contrast, the sub handle 60 may include the single grip lever 624, or may include a desired number of the grip levers 624, such as three or more.

(B7) In the above-described first embodiment, the example is shown in which the operation portion 52 is configured to be able to switch between the first position at the axial direction inner side X1 and the second position further to the axial direction outer side X2 than the first position, by the manual operation by the user. In contrast, a configuration may be adopted in which, when attaching the sub handle 60 to the handle attachment portion 16, at least a part of the handle attachment portion 16 displaces the operation portion 52 from the first position to the second position. According to the grinder 100 configured in this way, the sub handle 60 can be fixed to the handle attachment portion 16 by an operation of pressing the sub handle 60 against the handle attachment portion 16, without the manual operation of the operation portion 52 by the user. Note that, in this case, the user can remove the sub handle 60 fixed to the handle attachment portion 16 by displacing the operation portion 52 from the first position to the second position by a manual operation.

The present disclosure is not limited to the above-described embodiments, and can be realized by various configurations insofar as they do not depart from the gist and scope of the present disclosure. For example, technological features in the embodiments corresponding to technological features in each of modes listed in the Summary of the invention can be switched or combined as appropriate, in order to resolve some or all of the above-described problems, or in order to achieve some or all of the above-described effects. Further, those technological features can be omitted as appropriate insofar as they are not described as being essential in the present specification.

### DESCRIPTION OF REFERENCE NUMERALS

10 Housing, 11 Motor housing, 13 Controller housing, 14 Paddle switch, 15 Gear housing, 16 Handle attachment portion, 18 Grip portion, 19 Switch, 20 Motor, 21 Output shaft, 22 Drive bevel gear, 30 Spindle, 32 Driven bevel gear, 42 Shaft portion, 50 Fixing mechanism, 52 Operation portion, 54 Outer cylinder, 55 Pin, 56 Inner cylinder, 56W Inner surface, 57 biasing cylinder, 58 Fixing portion, 59 Spring, 60 Sub handle, 62 Main body, 64 Shaft portion, 68 Conversion mechanism, 70, 70b Detection unit, 71 Circuit board, 72 Main body, 72F Front surface, 72R Rear surface, 74 Cover, 75 Switch unit, 76 Pressing portion, 77 Plate portion, 78 Guide, 79 Shaft portion, 80 Electrode unit, 82 Outer electrode, 82E One end, 82F Other end, 82P Protrusion, 83, 83A, 83B, 83C Lead wire, 84 Inner electrode, 84E One end, 84F Other end, 91 Tip tool, 92 Wheel cover, 93 Battery, 94 Controller, 95 Dial, 100 Electric disc grinder, 112 Through hole, 114 Through hole, 132 Battery attachment portion, 142 Pressing portion, 144 Lock off lever, 146 Coil spring, 160 Cap, 161 Second contact surface, 162 Second engagement portion, 162B Bottom surface, 164 Groove, 166 Protruding portion, 167 Fourth engagement portion, 168 Insertion hole, 192 Plunger, 540 First contact surface, 542 Large diameter portion, 544 Small diameter portion, 545 Recess portion, 546 Recess portion, 560 Holding portion, 561 Third engagement portion, 564 Through hole, 568 Latching portion, 572 Flange, 574 Support portion, 620 Lever shaft, 622 Grip portion, 624 Grip lever, 625 Spring, 626 Flange portion, 642 Pin, 644 Through hole, 681 First shaft, 682 Second shaft, 683 Third shaft, 684 Fourth shaft, 686 First link, 688 Second link, 720 Through hole, 721 First restricting portion, 722 Second restricting portion, 724 Electrode housing portion, 726 Lead wire housing portion, 732 Plunger, 760 Intermediate member, 780 Cover, 781 First through hole, 782 Second through hole, 820 Outer main body, 821 Outer first elastic portion, 821E One end, 821F Other end, 822 Outer second elastic portion, 823 Outer third elastic portion, 826 First terminal, 828 Opening, 831 First lead wire, 832 Second lead wire, 840 Inner main body, 841 Inner first elastic portion, 841E One end, 841F Other end, 842 Inner second elastic portion, 843 Inner third elastic portion, 846 Second terminal, 848 Opening, 624E1 End portion, 624E2 End portion, DX Axial direction, TX Drive axis, HX Center axis, RX Rotational axis

1. A power tool comprising:
a motor including an output shaft configured to rotate around a motor rotation axis;
a housing the motor, and including a plurality of handle attachment portions;
a handle extending in one direction, and detachably attached to any one of the plurality of handle attachment portions; and
a controller configured to control driving of the motor, wherein
the handle includes
a main body portion including a grip portion configured to be grippable by a user, and
a shaft portion configured to be movable to a protruding position in which the shaft portion protrudes from the main body portion toward the plurality of handle attachment portions,
the housing includes a detection mechanism including a plurality of detection portions corresponding to the plurality of handle attachment portions, the plurality of detection portions being pressed by the shaft portion disposed at the protruding position when the handle is attached to the plurality of handle attachment portions, and
the detection mechanism outputs a signal to the controller, in response to the plurality of detection portions being pressed by the shaft portion.

2. The power tool according to claim 1, wherein
the handle further includes (i) a pressing detection portion provided on the grip portion and pressed as a result of the user gripping the grip portion, and (ii) a conversion mechanism configured to convert an operation of the pressed pressing detection portion into a linear movement of the shaft portion, and
the shaft portion is configured to (i) be disposed at a housed position at which the shaft portion is housed in the main body portion when the user is not gripping the grip portion, and (ii) be disposed at the protruding position by the pressing detection portion and the conversion mechanism when the user grips the grip portion.

3. The power tool according to claim 1, wherein
the detection mechanism further includes
(i) an inner electrode disposed surrounding the motor rotation axis, and (ii) an outer electrode disposed further to an outer side in a radial direction than the inner electrode, and disposed surrounding the inner electrode, and
the detection mechanism outputs the signal to the controller in response to at least a part of the outer electrode pressed by the shaft portion being electrically connected to the inner electrode.

4. The power tool according to claim 3, wherein
the outer electrode includes (i) a conductive outer main body portion extending in a circumferential direction centering on the motor rotation axis, and (ii) an outer first elastic portion and an outer second elastic portion connected to the outer main body portion and having conductive properties and elasticity, and
the outer first elastic portion and the outer second elastic portion function as the plurality of detection portions, and are electrically connected to the inner electrode as a result of being pressed by the shaft portion.

5. The power tool according to claim 4, wherein
the outer first elastic portion is a long plate including (i) a one end portion connected to the outer main body portion, and (ii) another end portion configured as a free end, and being pressed by the shaft portion,
a width of the other end portion is configured to be narrower than a width of the one end portion, and
the other end portion is electrically connected to the inner electrode as a result of being pressed by the shaft portion.

6. The power tool according to claim 4, wherein
the inner electrode includes (i) a conductive inner main body portion extending in the circumferential direction centering on the motor rotation axis, and (ii) an inner first elastic portion and an inner second elastic portion connected to the inner main body portion and having conductive properties and elasticity, and
the inner first elastic portion and the inner second elastic portion are disposed at positions corresponding to the outer first elastic portion and the outer second elastic portion, and are electrically connected to the outer first elastic portion and the outer second elastic portion pressed by the shaft portion.

7. The power tool according to claim 6, wherein
the inner first elastic portion is a long plate including (i) a one end portion connected to the inner main body portion, and (ii) another end portion configured as a free end, and being electrically connected to the outer first elastic portion pressed by the shaft portion,
a width of the other end portion is configured to be narrower than a width of the one end portion, and
the other end portion is electrically connected to the outer electrode pressed by the shaft portion.

8. The power tool according to claim 3, further comprising:
a restricting portion provided between the outer electrode and the inner electrode, and configured to restrict contact between the outer electrode and the inner electrode.

9. The power tool according to claim 1, wherein
the handle further includes a fixing mechanism configured to be switchable between a fixing state of fixing the handle attached to the plurality of handle attachment portions, and a non-fixing state in which the handle is removable from the plurality of handle attachment portions,
the fixing mechanism includes (i) an operation portion configured to be switchable between a first position and a second position closer to the main body portion than the first position, and (ii) a fixing portion, and
the fixing portion is (i) configured to be disposed at an attaching position when the operation portion is disposed at the second position, the handle being attachable to the plurality of handle attachment portions at the attaching position, and (ii) configured to be disposed at a fixing position when the operation portion is disposed at the first position, the fixing position being a position of fixing the handle attached to the plurality of handle attachment portions.

10. The power tool according to claim 9, wherein
the fixing mechanism further includes an urging member configured to urge the operation portion from the second position toward the first position.

11. The power tool according to claim 9, wherein
the fixing mechanism further includes (i) an outer cylinder connected to the operation portion, and configured to move in parallel to an extending direction of the shaft portion, and (ii) an inner cylinder including a holding portion configured to movably hold the fixing portion, the inner cylinder being movably housed in the outer cylinder,
the inner cylinder is configured to receive the plurality of handle attachment portions in the interior of the inner cylinder, and
with respect to the fixing portion, (i) at the fixing position, movement of the fixing portion to the outer side in the radial direction is restricted by the outer cylinder, and the fixing portion is configured to protrude to the interior of the inner cylinder and engage with the plurality of handle attachment portions received in the interior of the inner cylinder, and (ii) at the attaching position, the fixing portion is configured to retract further to the outer side in the radial direction than an inner surface of the inner cylinder, and not engage with the plurality of handle attachment portions received in the interior of the inner cylinder.

12. The power tool according to claim 11, wherein
the shaft portion is disposed further to an inner side in the radial direction than the outer cylinder and the inner cylinder, and is configured to be movable with respect to the outer cylinder and the inner cylinder.

13. The power tool according to claim 9, wherein
the handle further includes (i) a pressing detection portion provided on the grip portion and pressed as a result of the user gripping the grip portion, and (ii) a conversion mechanism configured to convert an operation of the pressed pressing detection portion into a linear movement of the shaft portion, and
the shaft portion is configured to (i) be disposed at a housed position at which the shaft portion is housed in the main body portion when the user is not gripping the grip portion, and (ii) be disposed at the protruding position by the pressing detection portion and the conversion mechanism when the user grips the grip portion.

14. A power tool comprising:
a housing including a plurality of handle attachment portions; and
a handle extending in one direction, and detachably attached to any one of the plurality of handle attachment portions, wherein
the handle includes
a main body portion including a grip portion configured to be grippable by a user, and
a fixing mechanism configured to be switchable between a fixing state of fixing the handle attached to the plurality of handle attachment portions, and a non-fixing state in which the handle is removable from the plurality of handle attachment portions,
the fixing mechanism includes (i) an operation portion configured to be switchable between a first position and a second position closer to the main body portion than the first position, and (ii) a fixing portion, and
the fixing portion is (i) configured to be disposed at an attaching position when the operation portion is disposed at the second position, the handle being attachable to the plurality of handle attachment portions at the attaching position, and (ii) configured to be disposed at a fixing position when the operation portion is disposed at the first position, the fixing position being a position of fixing the handle attached to the plurality of handle attachment portions.

15. The power tool according to claim 14, wherein
the fixing mechanism further includes an urging member configured to urge the operation portion from the second position toward the first position.

16. The power tool according to claim 14, wherein
the fixing mechanism further includes (i) an outer cylinder connected to the operation portion, and configured to move in parallel to an extending direction of the handle, and (ii) an inner cylinder including a holding portion configured to movably hold the fixing portion, the inner cylinder being movably housed in the outer cylinder,
the inner cylinder is configured to receive the plurality of handle attachment portions in the interior of the inner cylinder, and
(i) at the fixing position, movement of the fixing portion to an outer side in the radial direction is restricted by the outer cylinder and the fixing portion is configured to protrude to the interior of the inner cylinder and engage with the plurality of handle attachment portions received in the interior of the inner cylinder, and (ii) at the attaching position, the fixing portion is configured to retract further to the outer side in the radial direction than an inner surface of the inner cylinder, and not engage with the plurality of handle attachment portions received in the interior of the inner cylinder.
